(19) United States
(12) Patent Application Publication
(10) Pub. No.: US 2026/0199161 A1
(43) Pub. Date: Jul. 16, 2026

(54) LIFTING DEVICE AND ASSOCIATED METHODS

(71) Applicant: Redline Innovations, Inc., Melbourne Beach, FL (US)

(72) Inventors: Michael Pannucci, Melbourne, FL (US); Robert Clark, Melbourne, FL (US)

(73) Assignee: Redline Innovations, Inc., Melbourne Beach, FL (US)

(21) Appl. No.: 19/429,438

(22) Filed: Dec. 22, 2025

Related U.S. Application Data
(63) Continuation-in-part of application No. 18/640,148, filed on Apr. 19, 2024, now Pat. No. 12,502,325.
Application No. 18/640,148 is a continuation-in-part of application No. 17/936,171, filed on Sep. 28, 2022, now abandoned.
(60) Provisional application No. 63/250,531, filed on Sep. 30, 2021.

(51) Int. Cl. A61G 7/10

(52) U.S. Cl. CPC A61G 7/1015; A61G 7/1046; A61G 7/1051; A61G 7/1059

(57) ABSTRACT

A lifting device is provided and may include a pair of side members movable between a collapsed position and an extended position. The lifting device may also include a top support member connected to a top of the pair of side members. The lifting device may also include a front member and a side member each moveable between a collapsed position and an extended position. Both the front member and the side member may have a first end and a second end connected to upper side portions of the pair of side members. The lifting device may further include a hoist member that is removably carried by the top support member.

### RELATED APPLICATIONS

This application is a continuation-in-part application of and claims priority under 35 U.S.C. § 120 of U.S. patent application Ser. No. 18/640,148 (Attorney Docket No. 901.00007) filed on Apr. 19, 2024 and titled LIFTING DEVICE AND ASSOCIATED METHODS, which in turn is a continuation-in-part application of and claims priority under 35 U.S.C. § 120 of U.S. patent application Ser. No. 17/936, 171 (Attorney Docket No. 901.00005) filed on Sep. 28, 2022 and titled LIFTING DEVICE AND ASSOCIATED METHODS, which in turn claims priority under 35 U.S.C. § 119(e) of U.S. Provisional Patent Application Ser. No. 63/250,531 (Attorney Docket No. 901.00004) filed on Sep. 30, 2021 and titled LIFTING DEVICE AND ASSOCIATED METHODS. The contents of these applications are incorporated herein by reference.

### FIELD OF THE INVENTION

The present invention relates a lifting device and, more specifically, to a lifting device for use in the healthcare field to assist with lifting of patients in various medical scenarios.

### BACKGROUND OF THE INVENTION

In many lines of work there are occasions that involve lifting and sometimes carrying an individual who is incapable of picking themselves off the ground, or incapable of moving from one place to another, such as from a chair to a bed, or a bed to another bed. It can often be difficult or dangerous for a worker to lift such individuals, especially if the worker is small in stature, or when the individual in need of help is heavier set. These dangerous situations run the risk of causing injury and/or discomfort to either the worker or the individual in need of help.

This has created a need for a device that can be used to lift individuals in a safer manor to reduce that chances of injuries or discomfort from taking place. Especially in cases where the individual in need of assistance is larger than the worker trying to assist the individual. There are some devices already available in the prior art which attempt to remedy these situations. Such as U.S. Pat. No. 9,814,644 (hereinafter “the '644 patent”) for a “lifting device and associated methods and U.S. patent application Ser. No. 17/936,171 (hereinafter “the '171 application”) for a “lifting device and associated methods”. The '644 patent was useful and has helped a number of people over the years, but it became apparent over time there was a need for a device that could laterally expand to be used to lift individuals from or around furniture and objects.

It also became apparent that wheels could not be added to the '644 patent since it would make it unstable, so a wider more stable structure of a lifting device would be needed so that wheels could be added to the lifting device for transporting lifted individuals. Moreover, there was an apparent need for a lifting device that could be horizontally expandable and contractible, so that the lifting device could be used over a variety of furniture, objects, and environments. Ideally, a lifting device would contain these features and also be disassemble-able for ease of transportation and storing the lifting device when the lifting device is not in use.

The '171 application was also useful, but it has become apparent that there was a need for a lifting device that could laterally expand under its own power and be used to lift individuals from the ground or from or around furniture and objects. With this, it also be apparent that more than one hoist assembly would need to be added so that the lifting device could laterally expand under its own power. Additionally, there was an apparent need for a lifting device that could be further horizontally collapsible and expandable so that the lifting device did not require disassembly for ease of transportation and storage when the lifting device is not in use.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a lifting device that includes a pair of side members movable between a collapsed position and an extended position and a top support member. The top support member may have a first end rotatably connected to a top of a first one of the pair of side members. The top support member may also include a second end positioned opposite the first end and removably connected to a top of a second one of the pair of side members.

The lifting device may also include a front member moveable between a collapsed position and an extended position. The front member may have a first end connected to an upper side portion of the first one of the pair of side members, a second end connected to an upper side portion of the second one of the pair of side members, and a medial hinged portion. The lifting device may also include a rear member moveable between a collapsed position and an extended position. The rear member may have a first end connected to an upper side portion of the first one of the pair of side members, a second end connected to an upper side portion of the second one of the pair of side members, and a medial hinged portion. The lifting device may further include a hoist member that is removably carried by the top support member.

The lifting device may still further include a pair of opposing side support members. A first one of the pair of side support members may be connected to the first one of the pair of side members. A second one of the pair of side support members may be connected to the second one of the pair of side members.

Each of the pair of side members may include a plurality of side member legs that are in a nested configuration. The nested configuration may be defined as an upper side member leg of the plurality of side member legs of each of the pair of side members being sized to slidably engage a side member leg positioned therebelow. The collapsed position of each of the pair of side members may be defined as at least one of the plurality of side member legs slidably engaging an adjacent one of the plurality of side member legs positioned therebelow so that the upper side member legs are positioned interior to the side member legs positioned therebelow. The extended position of each of the pair of side members may be defined as each of the plurality of side member legs being extended outwardly from the adjacent one of the plurality of side member legs.

The collapsed position of each of the front member and the rear member may be defined as the hinged medial portion being moved to bring the first end and the second end in closer proximity to one another. The top support member may be moveable between an engaged position and a disengaged position. The engaged position may be defined as the top support member being in a substantially horizontal position and the second end of the top support member engaging the upper side portion of the second one of the pair of side members. The disengaged position may be defined as the top support member being in a position other than the substantially horizontal position, the second end of the top support member being disengaged from the upper side portion of the second one of the pair of side members, and the first end of the top support member being rotated in a downwardly direction.

The lifting device may further include a connecting support member connected to each of the pair of side members. The lifting device may still further include a lock member carried by the connecting member. The lock member is moveable between a locked position and an unlocked position. When in the locked position, the plurality of side member legs are prevented from slidably moving. When in the unlocked position, the plurality of side member legs can slidably move between the collapsed position and the extended position. The lifting device may also include at least one wheel member connected to at least one of the pair of side members.

### BRIEF DESCRIPTION OF THE DRAWINGS

Some embodiments of the present invention are illustrated as an example and are not limited by the figures of the accompanying drawings, in which like references may indicate similar elements.

FIG. 1 is a perspective view of a lifting device according to the present invention.

FIG. 2 is a perspective view of an upper portion of the lifting device illustrated in FIG. 1.

FIG. 3 is a perspective view of the lifting device illustrated in FIG. 1 in use to lift a person over an item of furniture.

FIG. 4 is a perspective view of the lifting device illustrated in FIG. 1 in use to suspend a person above the ground.

FIG. 5 is a perspective view of the lifting device illustrated in FIG. 1 in a horizontally collapsed position and a vertically extended position and in use to suspend a person above the ground.

FIG. 6 is a perspective view the lifting device illustrated in FIG. 5 in a horizontally collapsed position and a vertically collapsed position.

FIG. 7 is a perspective and environmental view of the lifting device illustrated in FIG. 1 in a horizontally collapsed position and a vertically extended position being used to suspend a person above the ground while another person (or user) pushes and wheels the lifting device while the person is suspended.

FIG. 8 is a perspective view of an upper portion of the lifting device illustrated in FIG. 1 and in the horizontally extended position.

FIG. 9 is a perspective view of a remote of the lifting device illustrated in FIG. 1.

FIG. 10 is a perspective and environmental view of the lifting device illustrated FIG. 1 in a disassembled state and being carried by a person.

FIG. 11 is a perspective view of the upper portion of the lifting device illustrated in FIG. 1 in a fully collapsed state.

FIG. 12 is an exploded perspective and environmental view of the lifting device illustrated in FIG. 1 that is disassembled and being carried by a person with an illustration of the placement of a front shield member on the lifting device.

FIG. 13 is a perspective view of a lifting device according to the present invention, shown with hoist assemblies and top support members and in the extended position.

FIG. 14 is a perspective view of the lifting device illustrated in FIG. 13 in the collapsed position.

FIG. 15 is a schematic diagram of the lifting device illustrated in FIG. 13.

FIG. 16 is a partial schematic view of the hoist assembly and top support member illustrated in FIG. 13.

FIG. 17 is a schematic diagram of the lifting device illustrated in FIG. 13, shown in communication with a network and with a remote.

FIG. 18 is a front perspective view of a lifting device configured in a collapsed position according to an embodiment of the present invention.

FIG. 19 is a rear perspective view of the lifting device illustrated in FIG. 18.

FIG. 20 is a partial perspective view of an upper portion of the lifting device illustrated in FIG. 18.

FIG. 21 is a perspective view of the lifting device illustrated in FIG. 18 and showing a front member and a rear member both configured in an extended position.

FIG. 22 is a perspective view of the lifting device illustrated in FIG. 21 and showing a hoist member connected to a top support member.

FIG. 23 is a perspective view of the lifting device illustrated in FIG. 21 and showing side members thereof in an extended position.

FIG. 24 is a side elevation and environmental view of the lifting device illustrated in FIG. 23 being used to lift a patient while the patient is in a supine position.

FIG. 25 is a front elevation and environmental view of the lifting device illustrated in FIG. 23 being used to support a patient while the patient is in a standing position.

FIG. 26 is a front elevation view of the lifting device illustrated in FIG. 23 and showing the side members in a fully extended position.

FIG. 27 is a front elevation view of the lifting device illustrated in FIG. 26 and showing the side members in a partially collapsed position.

FIG. 28 is a front elevation view of the lifting device illustrated in FIG. 26 and showing the side members in a collapsed position and showing the hoist member connected to the top support member.

FIG. 29 is a front elevation view of the lifting device illustrated in FIG. 28 and having the hoist member removed.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a lifting device 27. The lifting device 27 according to embodiments of the present invention may advantageously be used to assist in lifting a person, such as a patient, from the ground. For example, the lifting device 27 may be used by hospital personnel to lift patients, or to assist patients that are not otherwise mobile, or who may need to be moved from one position to another, e.g. from a wheelchair to a bed. The lifting device 27 according to the present invention is also moveable between collapsed and extended positions, as will be discussed in greater detail below, and can therefore advantageously be used in connection with emergency personnel. More particularly, emergency personnel can readily collapse the lifting device 27 so that it can be stored on an emergency vehicle, such as an ambulance or a firetruck, for example. Those skilled in the art will appreciate that the lifting device 27 according to embodiments of the present invention may advantageously be used for any number of necessary lifting necessities in any number of different situations.

The lifting device 27 according to the present invention may be used to prevent back injury, for example, of personnel that may be responsible for lifting patients, or other persons. For example, and in reference to ambulance personnel, there are several calls to assist fallen patients. Back injuries may occur to ambulance personnel when attempting to lift such patients, especially when the patient is located on the ground. Using the lifting device 27 according to embodiments of the present invention may advantageously reduce, or even eliminate, such back injuries that ambulance personnel may sometimes suffer. A similar situation occurs when hospital personnel help patients from the ground or when assisting a patient in moving from one position to another. The lifting device 27 according to the present invention may be used to reduce the potential for such injuries.

Further, use of the lifting device 27 according to the present invention may greatly reduce the risk of injury to a patient. The process for lifting a patient that may be positioned on the ground, or moving the patient from one location to another, may be dangerous for the patient. The lifting device 27 according to embodiments of the present invention may advantageously be used to readily move the patient as necessary, while simultaneously reducing the risk of injury to the patient.

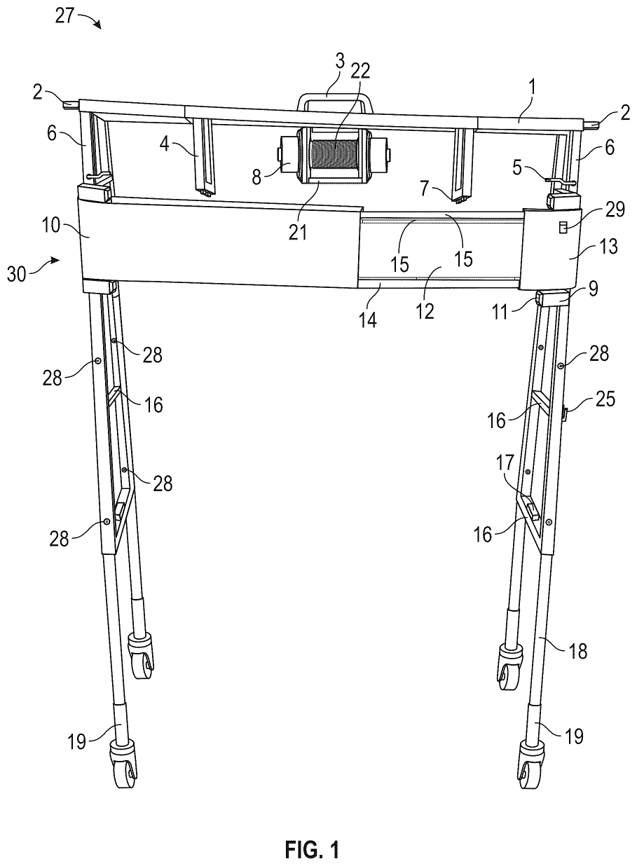

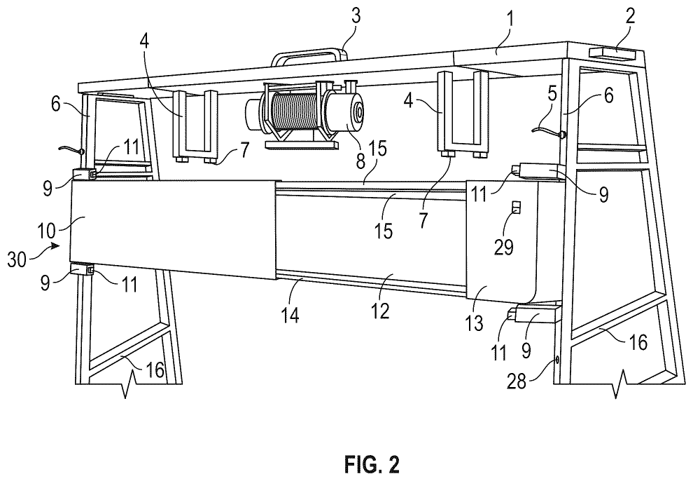

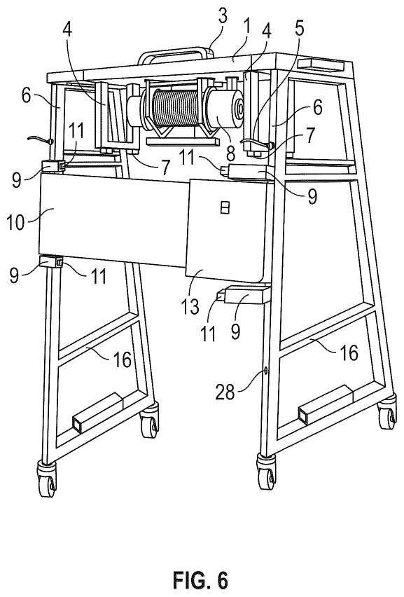

Referring now more specifically to FIGS. 1-12, additional features of lifting device 27 are now described in greater detail. More specifically, the lifting device 27 may comprise a top member 1 located at the upper area of the lifting device 27. As will be described in greater detail below, since the lifting device 27 is moveable between extended and collapsed positions, the top member 1 may also be moveable from an extended position to a collapsed position to minimized space required for storage of the lifting device and to allow for ease of transport of the lifting device 27 by a user, as perhaps best illustrated, for example, in FIGS. 6 & 10. The ease of transporting the device is further increased with the inclusion of a carry handle member 3 that may be used to carry the lifting device 27 when in a collapsed position. For example, the carry handle member 3 can be used when the lifting device 27 is being transported over rough terrain, ground, or to carry the lifting device more easily 27 as perhaps best illustrated in FIG. 9. While a single carry handle member 3 is shown, it is contemplated and included within the scope of the invention that any number of handles may be provided and that the handles may be located anywhere on the top member 1 or any other element of the lifting device 27 to advantageously facilitate lifting and carrying thereof.

The lifting device 27 may also comprise at the opposing ends of the top member 1 a side handle 2 on both ends. Each side handle 2 may be used to manipulate top member 1 when the lifting device 27 is fully assembled, disassembled, or collapsed or non-collapsed. Those skilled in the art will appreciate that the side handles 2 are an optional feature that provide additional advantages to the lifting device 27, and that the lifting device 27 may be provided with or without side handles 2 while still accomplishing the goals, features and advantages according to the present invention.

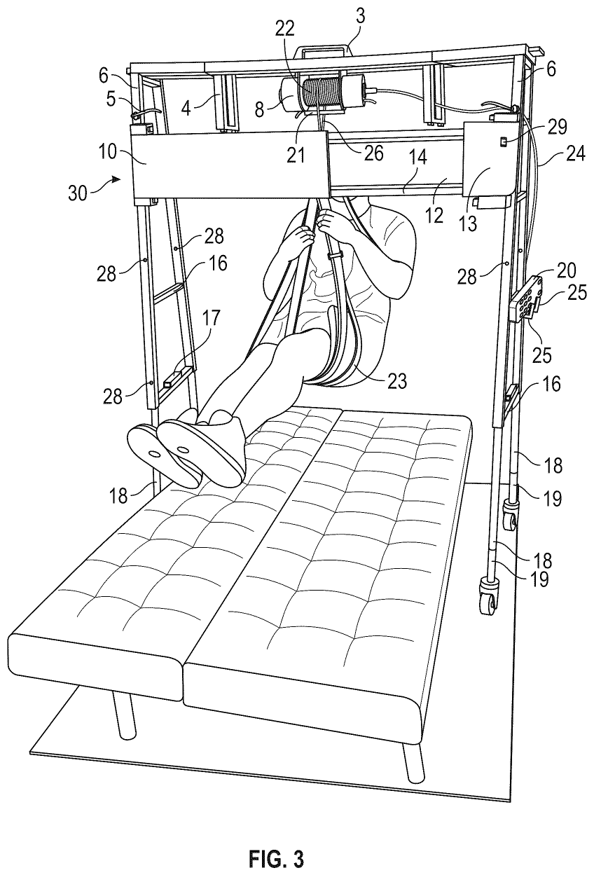

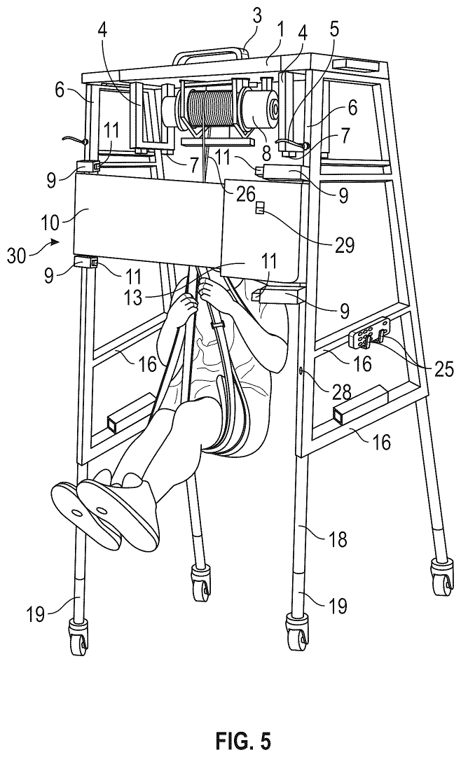

Referring now to FIGS. 1-4, & 11, the lifting device 27 according to embodiments of the present invention may further illustratively comprise a hoist assembly 8. The hoist assembly 8 may be fixedly attached to a lower surface of the top member 1. The hoist assembly 8 is illustrated as being positioned close to a center portion of the top member 1, but those skilled in the art will appreciate that the hoist assembly may be positioned anywhere in connection with the top member while still accomplishing the goals, features and advantages of the present invention. The hoist assembly 8 may be operable to supply the force necessary to lift a person or patient. The hoist assembly 8 can be configured to actuate a lifting force to lift a patient as described, depending on the intended application of the lifting device 27. The hoist assembly 8 may compose of a coiled member 22 located within the hoist assembly 8 fixedly connected to the hoist assembly 8 such that the coiled member 22 may have the ability to rotate about one of the coiled member's 22 axes. More specifically, the hoist assembly 8 may, for example, be provided by a winch. The hoist assembly 8 may further include a load member 26 that is rope-like and connected to the coiled member 22 that may be in a wrapped configuration so that the load member 26 is wound around the coiled member 22. A user operating the lifting device 27 may use the hoist assembly 8 to rotate the coiled member 22 around an axis such that the load member 26 is wound or unwound from around the coiled member 22 to control a person's position above the ground as illustratively shown in FIGS. 3, 5, & 7.

How a person is lifted with the lifting device is discussed in more detail below. The hoist assembly 8 may further comprise a bar member 21 extending the length of the coiled member 22 that may be included to ensure that the load member 26 does not tangle when wound or unwound from the coiled member 22, and to reduce other possible issues with the load member 26 when the lifting device 27 is in use. The functionality of the coiled member 22 and the load member 26 is discussed in more detail below.

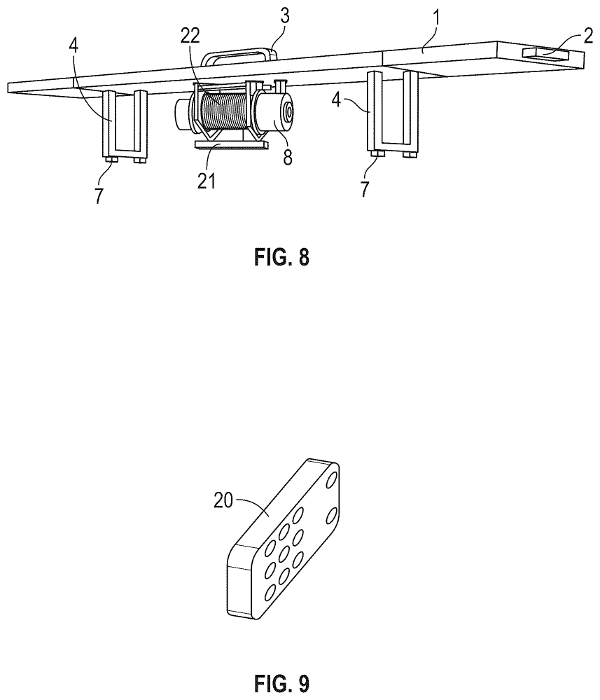

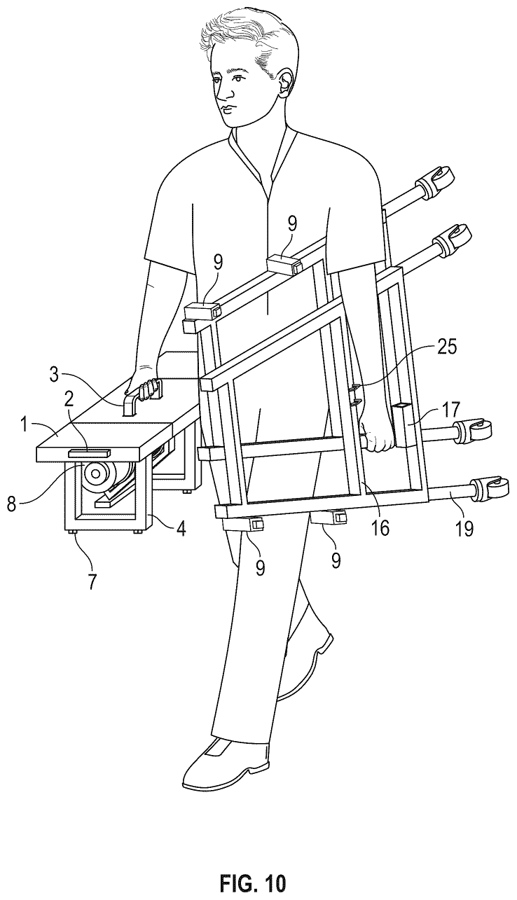

The lifting device 27 may also comprise a U-shaped member 4 located on the bottom side of top member 1 and near each end of the top member 1. As illustrated, for example, in FIG. 8, a pair of U-shaped members 4 may be provided and may be positioned on either end of the coiled member 22 to oppose one another. Each U-shaped member 4 may be placed such that each does not interfere with the ability for the lifting device 27 to collapse. Placement of the U-shaped members 4 when the lifting device is in its collapsed state is best illustratively shown in FIGS. 6 and 10. Protrusion member 7 that may act as leg members may be fixedly connected to bottom portions of the U-shaped members 4. The U-shaped members 4 may work in concert with the protrusion members 7 such that they support the top member 1 when the top member has been removed from the lifting device 27 and the top member 1 has been placed on a surface. The U-shaped members 4 may also act as legs and the protrusion members 7 may act as feet. Those skilled in the art will appreciate that the U-shaped members 4 and protrusion members 7 prevent the hoist assembly 8 from touching a surface that the top member 1 has been placed upon when the top member 1 has been removed from the lifting device 27.

With reference to FIGS. 1-4, the lifting device 27 may also include a front shield member 30 connected to the upper portions of the side members 6. The front shield member 30 may include a first shield member 10 and a second shield member 13 connected to the first shield member 10. The second shield member 13 may include a small shield square 29 located on the front facing area of the second shield member 13. The small shield square 29 may be a locking member to lock the front shield member 30 in a collapsed position when the lifting device 27 is moved from a horizontally extended position to a horizontally collapsed position, as will be discussed in greater detail below. The front shield member 30 may also include a center shield member 12 connected to a rear portion of the second shield member 13 such that it lays horizontally to slide underneath the first shield member 10 when the lifting device 27 is in the collapsed position as illustratively shown in FIG. 6. The front shield member 30 may also illustratively include a lower sliding support member 14 located at the lower end of first shield member 10 and second shield member 13. The lower sliding support member 14 may be adapted so that may be collapsed when the lifting device 27 is collapsed by a user. The front shield member 30 may also illustratively include a pair of upper sliding support members 15 on the upper portion of the front shield member oriented horizontally and preferably behind both the first shield member 10 and the second shield member 13. The upper sliding support member 15 may be adapted so that may be able to collapse when the lifting device 27 is collapsed by a user. Accordingly, the front shield member 30 may be moved between an extended position (illustrated, for example, in FIG. 1) and a collapsed position (illustrated, for example, in FIGS. 5-7). Further, the first shield member 10 slidably engages the second shield member 13 to allow for the front shield member 30 to be moved between the extended and the collapsed positions.

With reference to FIGS. 1 & 3-7, the lifting device 27 may further comprise a pair of side members 6. Each side member 6 may be adapted to allow for the bottom side of opposite ends of the top member 1 to be rested thereon. More specifically, and as perhaps best illustrated in FIG. 1, the top member 1 may be positioned to rest on the side members 6 so that the side members provide support to the top member when the lifting device 27 is in use. Each side member 6 can be made at various angles, however, it is preferable that the width of the side member 6 expands or tapers outwardly from its top to its bottom. Those skilled in the art will find a greater width of expansion of a side member 6 provides enhanced stability of the lifting device 27. Each side member 6 may also illustratively include a plurality of horizontal connecting support members 16.

Each horizontal connecting support member 16 can vary in angle and placement along the inside of each side member 6. Those skilled in the art, however, will appreciate that any number of connecting support members 16 at various angles or sizes may be provided while still accomplishing the goals, features, and objectives according to the embodiments of the present invention. The side member 6 may also include a pair of hook members 25 located on the outer side of a connecting support member 16 that may provide a place to store a remote 20.

The remote 20 may be used with the lifting device 27 to remotely control the automated characteristics of the enumerated invention which may be through wired or wireless communication via the user inputs on the remote 20. However, those skilled in the art will appreciate that a remote is not required for the embodied invention to operate. For example, the embodied invention may be operated by buttons placed elsewhere on the invention that are in communication with the hoist assembly 8 to move the hoist assembly up and down, or the lifting device 27 may be configured to operate without the need for a remote or buttons.

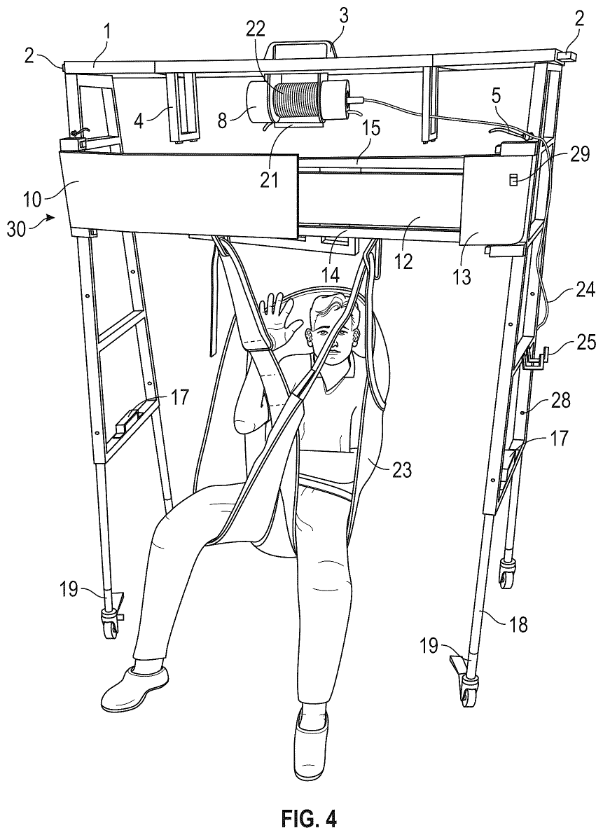

Furthermore, it is not necessary that the lifting device 27 be configured to operate by electric power and may instead be made to operate by manual force or other type of force, including but not limited to hydraulic power. In the preferred embodiment, however, the lifting device 27 which operates on electric power may comprise a wire member 24 used to supply the electric power to the hoist member 8 as illustrated, for example, in FIGS. 3 and 4. The wire member 24 may be connected to the hoist member 8 and any suitable power source. For example, for use of the lifting device 27 by ambulance personnel the lifting device 27 may be powered by plugging the wire member 24 to some power source outlet on the ambulance or other vehicle. Alternatively, the lifting device 27 may also be powered by the wire member 24 being connected to some battery supply of electric power. It is also contemplated that a battery may be included on the lifting device 27 and in electrical communication with the hoist assembly 8 to provide power so that the hoist assembly may be readily moved up and down.

Another alternative to electrically power the lifting device 27 is to have the wire member 24 transmit power from plugging into electric wall outlets. Those skilled in the art will appreciate that an electric powered lifting device 27 can be powered by a number of different sources of electric power while still accomplishing the goals, objectives, and features according to the embodiments of the present invention. In a manual configuration, those skilled in the art will appreciate that the device may include a crank member (not shown), that is connected to the coiled member 22 so that a user can crank the load member 26 to move the seat member 23 between an elevated and a lowered position.

Referring to FIGS. 1-8, lifting device 27 may also comprise of angled members 5 connected to the upper front sides of each side member 6. The angled member 5 may be used to lock the lifting device in place. The angled member 5 may work as a clamping lever used to lock the side members 28 in place to restrict the side members' 28 movement. Each angled member 5 may be turned clockwise or counterclockwise to restrict or unrestrict the movement of a side member 28. Those skilled in the art will appreciate that there are a plurality of different mechanisms that can be used to accomplish the functionality desired to restrict and unrestrict the leg members 28 while still accomplishing the goals, features, and advantages of lifting device 27.

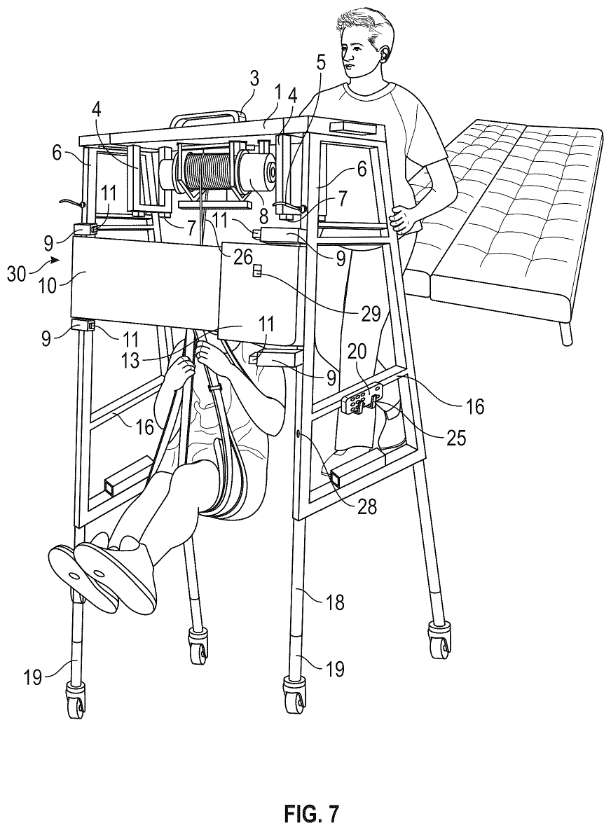

Referring now to FIGS. 1-7, the lifting device 27 may also comprise of a number of arm members 9 connected to upper front facing sides of the side members 6 that may abut sides of the front shield member 30. The lifting device 27 may also include arm cap members 11 attached to the ends of each of the arm members 9. The arm members 9 may illustratively provide enhanced support to the front shield member 30 when the front shield member 30 is connected to the side members 6 as illustrated, for example, in FIG. 7.

Referring now specifically to FIGS. 1, 3 & 4, the lifting device 27 may comprise overlay members 17 connected to the upper area of one or more of the lower connecting support members 16 and oriented parallel to the connecting support member 16 the overlay member 17 is connected to. The overlay members 17 may, for example, be used to receive a bench seat member (not shown) so that the hoist can be used to allow a patient being moved to sit while the lifting device is being used. For example, when the bench seat member is installed to be connected to the overlay members 17, the lifting device may be used to move a patient from a bed to a shower, allow the patient to be in a seated position in the shower, and remain connected to the seat member 23 to reduce a chance of falling.

Referring to FIGS. 1, 3-5, & 7, the lifting device 27 may illustratively include a number of leg members 18. Each leg member 18 may be configured to matingly slide into the lower portions of each side member 6. As perhaps best illustrated in FIG. 7, the leg members 18 are positioned to extend outwardly from each side member 6. Throughout the front facing areas of each side member 6 there may be a plurality of through holes 28 that may be used as locking mechanisms to configure the length of the leg members 18 and thus configure the height of the lifting device 27. In some embodiments, the lock mechanism in place at the through holes 28 can be a push button type lock that can be unlocked upon depression and remain locked when the button becomes raised upon ceasing depression. Alternatively, the through hole 28 locking mechanism may be a locking pin, which can be inserted once the through holes 28 align on the side member 6 and the leg member 18 to configure the height of the lifting device 27 by preventing longitudinal movement of the leg member 18. Other lock mechanisms may also be provided, as may be understood by those skilled in the art while still accomplishing the goals, features and advantages according to embodiments of the present invention. Moreover, the ability to raise or lower the height of the lifting device 27 advantageously allows the user to ensure the invention will be at the most convenient height given the embodied invention's intended use. For example, extending the length of the leg member 18 to a greater length advantageously allows for ease of use of the lifting device 27 over objects, such as furniture, as illustrated in FIG. 3.

The leg members 18 may also include a foot connection member 19 adapted and connected on the lower portion of each said leg member 18. This is illustratively shown in FIGS. 1, 3-5, 7, & 9. This advantageously provides enhanced stability to the lifting device. In other words, the foot connection members 19 may each have a flat configuration that may provide a more stable surface to support the lifting device 27. Those skilled in the art will appreciate that the foot connection members 19 may be inserted into a bottom portion of each of the leg members 18. Alternatively, the foot connection members 19 may be threadedly connected to the leg members 18. Those skilled in the art will appreciate that there are many configurations for connecting the foot connection members 19 to the leg members 18, and each configuration that is suitable for connecting the foot connection members 19 to the leg members 18 is contemplated and intended to be included within this disclosure.

In an alternative embodiment, the foot connection members 19 may be provided by casters or other wheeled devices. Using casters advantageously allow the lifting device 27 to be readily moved after a patient has been lifted. For example, it may be desirous to lift a patient from one location and move the patient to another area simply by moving the lifting device 27 that has casters as the foot connection members 19. This advantageously provides enhanced operation of the lifting device and allows for the lifting device 27 to be used to readily move patients while simultaneously reducing the risk of injury to persons that may be necessary to lift the patient.

The lifting device 27 may also include a seat member 23 that may be attached to the lifting device 27 with the load member 26 as illustratively shown in FIGS. 3-5, and 7. A plurality of different types of seat members 23 may be used with the lifting device 27 depending on the proportions of the person to be lifted or depending upon the desired physical manipulation of the person under the current circumstances. For example, in certain situations a certain type of seat member 23 may be more desirous to lift a large person, or a different type of seat member may be more desirous if the goal is to simply lift the person to rotate them to be on his or her side. Those skilled in the art will appreciate that many different types of seat members 26 can be used while still accomplishing the goals, features, and objectives according to embodiments of the present invention.

Referring now to FIGS. 3-5, & 7, the operation of the lifting device 27 is now described in greater detail. If, for example, a patient is on the ground (or floor) and needs to be lifted therefrom, the lifting device 27 according to the present invention may be used to achieve such a task. More specifically, a seat member 23 can be engaged onto or around the patient or person that needs to be lifted from the ground. Upon engaging the seat member 23, the seat member then may be attached to the load member 26. Upon attaching the seat member 23 to the load member 26, a user may then operate the hoist assembly 8 to being rotating the coiled member 22 such that the load member 26 wraps around the coiled member 22. As the load member 26 wraps around the coiled member 22 the load member's 26 portion unwound shortens resulting in the seat member 23, and thus also the patient that the seat member is engaged upon, to be lifted above the ground.

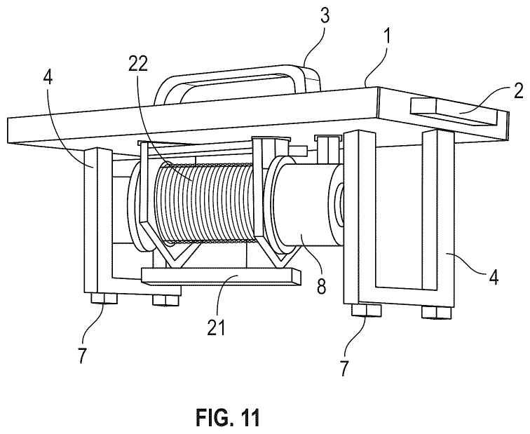

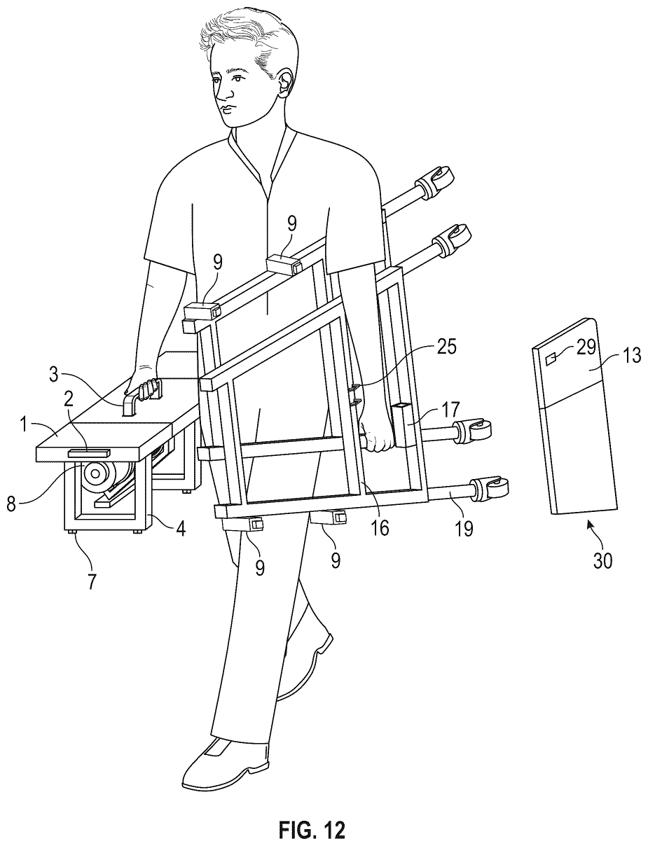

The lifting device 27 is advantageously configured for convenient setup and transportation. Referring more specifically to FIG. 10, the lifting device 27 may be disassembled and the leg members 6 may advantageously be configured to be flat for easier transportation. The top member 1 may conveniently be collapsed by a user when the lifting device 27 is disassembled. This advantageously provides for a more convenient form for which the top member 1 can be transported. Referring additionally to FIG. 11, transportation of the top member 1 is further made convenient when the carry handle member 3 is placed on the top side of the top member 1. The carry handle member 3 may provide a convenient way for a user to grip and carry the top member 1 when the lifting device 27 is disassembled. Furthermore, the front shield member 30 may also be collapsed to be in a more convenient travel form as illustrated in FIG. 12. Those skilled in the art will appreciate that it is not necessary to disassemble or collapse the lifting device 27 for transportation, and that the lifting device 27 is able to be transported in its fully assembled or uncollapsed form if needed.

Alternatively, the lifting device 27 may be transported in a fully assembled but fully collapsed form as illustrated in FIG. 6. This form is best suited when the lifting device is stored, but it is not found necessary to disassemble the lifting device 27. For example, in a hospital emergency room is may be found necessary to keep the lifting device 27 collapsed but assembled for the hospital personnel to have a faster response time when a patient has fallen onto the floor and is under emergency conditions.

As illustrated in FIG. 4, use of the hoist member 8 is optional to carry a patient around using the lifting device 27. If necessary, the seat member 23 being used with the lifting device 27 can be attached to other members (not shown) on the lifting device. For example, this may be desired when a large patient is capable of standing upright but is unable to walk (or has trouble walking), and the patient is too large to be transported easily by any other mode of transportation.

The components of the lifting device 27 according to embodiments of the present invention may advantageously be made with aluminum material. An aluminum material may be advantageous as it has high strength properties and low weight. Those skilled in the art will appreciate, however, that the lifting device 27 components may be made of any number of materials while still composting the goals, features, and objectives according to the present invention.

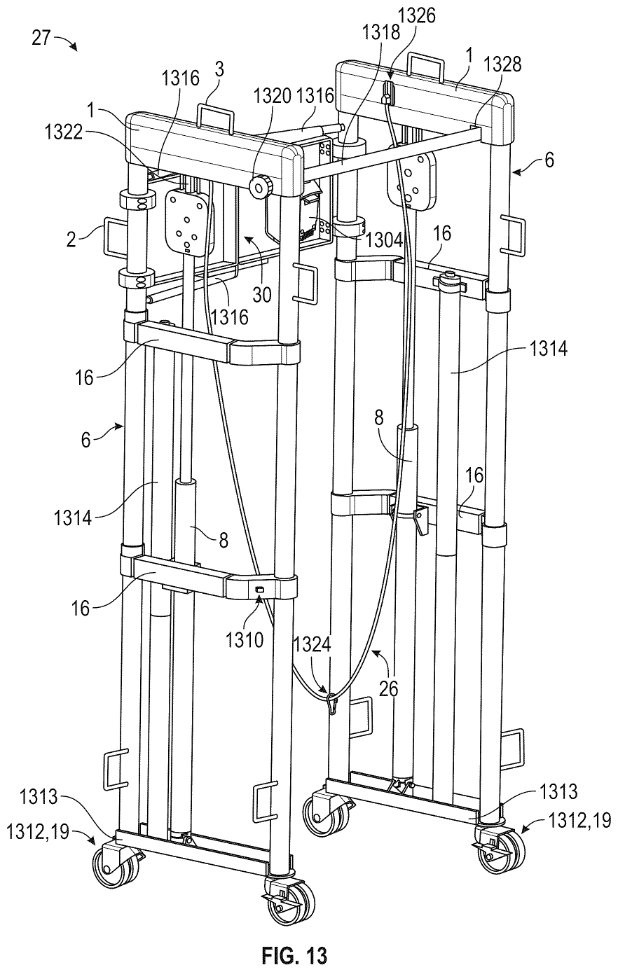

Now referring to FIGS. 13-15, details on some improved embodiments of the lifting device 27 may now be described. Embodiments of the present invention may include side members 6, top support members 1, hoist assemblies 8, and a front shield member 30. The side members 6 may be movable between a collapsed position and an extended position. In some preferred embodiments of the present invention, the side members 6 may be telescopically movable between the collapsed position and the extended position. Each side member 6 may include one or more leg members 18 which may be extending in parallel with one another. Each leg member 18 may be movable between a collapsed position and an extended position, and each leg member 18 may also be telescopically movable between the collapsed position and the extended position. Each side member 6 may also include one or more connecting support members 16. The connecting support members 16 may be extending between two or more of the leg members 18 of one of the side members 6. Each connecting support member 16 may have one end connected to a leg 18 of a side member 6 and another end connected to another leg 18 of the same side member 6. Each connecting support member 16 may be positioned horizontal to the leg members 18 that the connecting support member 16 is attached thereto.

One or more of the connecting support members 16 may include an engagement member 1310. The engagement member 1310 may be operable to move between an engaged position and a released position. When the engagement member 1310 is in the engaged position, the engagement member 1310 may prevent the leg members 18 and/or the side member 6 that is it attached thereto from moving and/or telescopically moving between the collapsed position and the extended position. When the engagement member 1310 is in the released position, the engagement member 1310 may be configured to allow the leg members 18 and/or the side member 6 that is it attached thereto from moving and/or telescopically moving between the collapsed position and the extended position. In some embodiments of the present invention, without limitation, the engagement member 1310 may comprise a button that when pressed, may move the engagement member 1310 to the released position, and that when the engagement member 1310 button is not being pressed, the engagement member 1310 may automatically move to the engaged position.

In some embodiments of the present invention, the engagement member 1310 may comprise an electronic actuator, such as, and without limitation, a solenoid. The engagement member 1310 may be in communication with a control unit 1702 and/or with a power unit 1304, and the engagement member 1310 may be operable to the selectively controlled with the control unit 1702 to move the engagement member 1310 between the engaged position and the released position. Further details on the control unit 1702 and the power unit 1304 follows below.

In some embodiments of the present invention, each side member 6 may include a connecting support member 16 on each portion of the side member 6 and/or on each portion of the legs 18 of the side member 6 that telescopically moves. In embodiments that include multiple connecting support members 16, one or more of the connecting support members 16 of each side member 6 may include an engagement member. For example, without limitation, each side member 6 of the lifting device 27 may include two connecting support members 16, and a lower one of the two connecting support members 16 may include an engagement member 1310, as illustrated in FIG. 13.

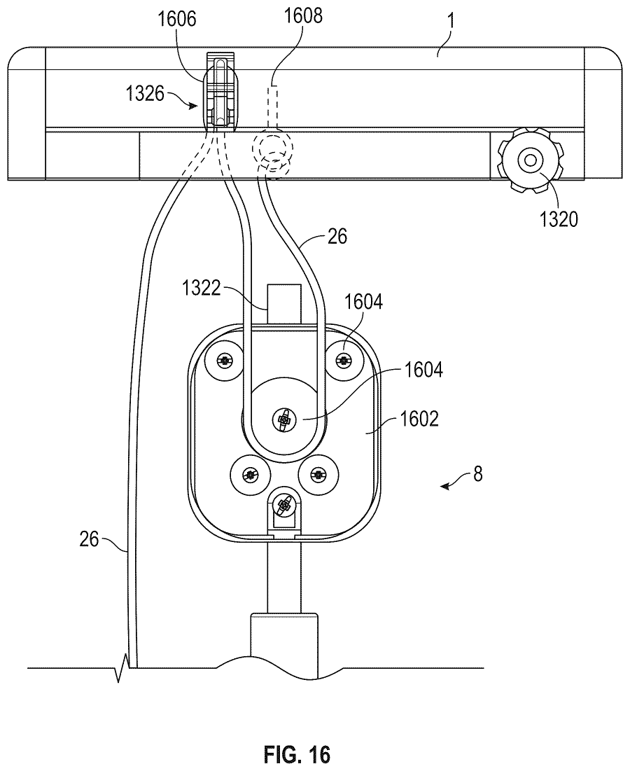

Now additionally referring to FIG. 16, each of the top support members 1 may be carried by and/or connected to a respective side member 6. The top support member 1 may be positioned at an upper portion of its respective side member 6. In some embodiments of the present invention. the top support member 1 may be extending between and attached to the upper portion of two or more legs 16 of its respective side member 6. The top support members 1 may cooperatively carry a load member 26. One end of the load member 26 may be carried by one of the top support members 1 and another end of the load member 26 may be carried by another one of the top support members 1. In some embodiments of the present invention, the top support members 1 may include a retention member 1608 carried thereby and to which one of the ends of the load member 26 may be attached. The top support members 1 may also include a top pulley 1606 carried thereby and to which the load member 26 may be slidingly carried thereby. Further details on the retention members 1608, top pulleys 1606 and the load member 26 follows below.

The front shield member 30 may be extending between the side members 6, and in some embodiments of the present invention, the front shield member 30 may be extending between the side members 6 at an upper portion of the side member 6. The front shield member 30 may be extending between the leg members 18 of the side members 6 and/or extending between one of the leg members 18 of each side member 6. Also, the front shield member 30 may be positioned extending between an upper portion of the leg members 18 and/or of one of the leg members 18 of each side member 6.

The front shield member 30 may be pivotally attached at one end to one of the side members 6 and/or to one of the leg members 18, and the front shield member 30 may be pivotally attached at a second end to another one of the side members 6 and/or to one of the leg members 18. The front shield member 30 may be movable between an extended position and a collapsed position. The collapsed position of the front shield member 20 may be defined as when the front shield member 30 is at least partially folded in on itself, and the extended position of the front shield member 20 may be defined as when the front shield member 20 is substantially uniformly coplanar with a two-dimensional plane. In some embodiments of the present invention, the front shield member 30 may comprise a first shield member 10 and a second shield member 13 that may have one side pivotally attached to a side of the first shield member 10. The first shield member 10 and the second shield member 13 may have a substantially similar and/or same size and/or shape. The collapsed position of the front shield member 30 may be defined as when the first shield member 10 and the second shield member 13 are pivotally moved in relation with one another to have a frontal face of each to be substantially facing one another.

The extended position of the front shield member 30 may be defined as when the first shield member 10 and the second shield member 13 are pivotally moved to have the frontal face of each to be aligned with one another along a two-dimensional plane and/or to have the frontal face of each of the first shield member 10 and the second shield member 13 to be substantially not facing one another. It is understood that the recitation of the frontal face of each of the first shield member 10 and the second shield member 13 to be substantially not facing one another means that a two-dimensional linear projection outwards from the frontal face of the first shield member 10 and of the second shield member 13 would not project onto the frontal face of one another. Further details on the front shield member 30, the first shield member 10, and the second shield member 13 follows below. For the purposes of increasing the level of terseness of the description of the present invention, the term front shield member 30 may be used to refer to any one or more of the front shield member 30, the first shield member 10, and/or the second shield member 13 individually, in combination, or in any combinations thereof without any limitation intended or implied thereby.

Some embodiments of the present invention may include one or more of a side handle 2 and a carry handle member 3, which me be referred to herein separately and/or collectively, without limitation, as handle member(s) 2, 3 and in any grammatical form thereof. The handle member(s) 2, 3 may be positioned on and/or attached to one or more portions of the top support member(s) 1, the side members 6, and the leg members 18. In some embodiments of the present invention, the handle member(s) 2, 3 may be positioned on and/or attached to one or more of the connecting support members 16. However, it is contemplated that the connecting support member 16 may act as a handle without the need of a handle member 2, 3 positioned on and/or attached thereto.

Although throughout the figures that handle member(s) 2, 3 may be illustrated as handles comprising a rigid material, such as, and without limitation, a metal plastic, and/or composite, it is contemplated that the handle member(s) 2, 3 may comprise a less-than-rigid or non-rigid material. For example, without limitation, the handle member(s) 2, 3 may comprise a less-than-rigid material and/or a non-rigid material such as, and without limitation, a non-rigid handle comprising one or more of textiles, cloth, woven fiberglass, resins, polymers, and any combinations thereof and any other material that may be used for the handle member(s) 2, 3 as may be understood by those who may have skill in the art. Those skilled in the art may notice and appreciate that the handle member(s) 2, 3 may allow for ease of handling, manipulation, travel, and manual movement of embodiments of the lifting device 27 when the lifting device 27 is in either the collapsed position or the extended position. However, those skilled in the art will notice and appreciate that embodiments of the lifting device may include none, or any number of handle member(s) 2, 3 which may also comprise any material while still accomplishing all the goals, features, and advantages of the embodiments of the present invention.

Continuing to refer to FIGS. 13-15, embodiments of the present invention may include one or more piston members 1316. The piston members 1316 may comprise a first end and a second end. The first end of the piston members 1316 may be attached to and/or pivotally connected to one of the side members 6 and/or one of the leg members 18, and the second end of the piston members 1316 may be attached to and/or pivotally connected to a side portion of the front shield member 30 and/or a side portion of the first shield member 10 and/or a side portion of the second shield member 13. The piston members 1316 may be configured to generate an extend force and/or to generate a collapse force. The extend force of the piston members 1316 may be defined as a force applied by the piston member 1316 between the side member 6/leg member 18 and the front/first/second shield member 30, 10, 13 that the piston member 1316 is attached to and/or pivotally connected to extend the piston member 1316 to an extended position and to move the front/first/second shield member 30, 10, 13 to the extended position. The collapse force of the piston members 1316 may be defined as a force applied by the piston member 1316 between the side member 6/leg member 18 and the front/first/second shield member 30, 10, 13 that the piston member 1316 is attached to and/or pivotally connected to collapse the piston member 1316 to a collapsed position and to move the front/first/second shield member 30, 10, 13 to the collapsed position.

In some embodiments of the present invention, the piston members 1316 may be configured to selectively generate and/or continually generate the extend force and/or the collapse force. In some other embodiments of the present invention, the piston members 1316 may be configured to be operable to selectively generate the extend force and/or the collapse force. Examples of the piston members 1316 include, without limitation, pneumatic, hydraulic, electrical, and/or mechanical pistons, actuators, struts, solenoids, and/or motors, and any combinations thereof and/or any other device that may be used as a piston member 1316 as described herein by those who may have skill in the art. For the purposes of the present invention, it should be understood by those skilled in the art that the movement of the piston members 1316 between the extended position and the collapsed position may be referred to, without limitation, as the piston members 1316 actuating between the extended position and the collapsed position.

In some embodiments of the present invention, an end of the piston member 1316, such as the second end of the piston members 1316, may be attached to and/or pivotally connected to the side portion of the front shield member 30 and/or the side portion of the first shield member 10 and/or the side portion of the second shield member 13 via a piston attachment member 1504. The piston attachment member 1504 may be configured to allow the piston member 1316 to be attached to, and pivotally move relative to, the side portion of the front shield member 30 and/or the side portion of the first shield member 10 and/or the side portion of the second shield member 13 that the second end of the piston member 1316 is attached therewith via the piston attachment member 1504. In some embodiments of the present invention, without limitation, the piston attachment member 1504 may be configured to allow for the second end of the piston member 1316 to slidingly move along the side of the front/first/second shield member 30, 10, 13 that the second end of the piston member 1316 is attached therewith via the piston attachment member 1504.

Some embodiments of the present invention may include a bar member 21 that may extend between the top support members 1. The bar member 21 may have two ends that may be each attached to a respective top support member 1. One end of the bar member 21 may be pivotally attached to one of the top support members 1, and the other end of the bar member 21 may be reversibly attached to the other top support member 1. The bar member 21 may comprise a bar connector 1320 at one end of the bar member 21, and the bar connector 1320 may be configured to be reversibly attached and/or removably attached to the respective end of the bar member 21 to one of the top support members 1. In some embodiments of the present invention, the bar member 31 may have two ends that may be each reversibly attached and/or removably attached to respective top support members 1, and the attachment of the two ends to its respective top support member 1 may be via respective bar connectors 1320 at each of the two ends. The bar member 21 may be moveable between a connected position and a stowed position. The extended position of the bar member 21 may be defined as when the bar member 21 is positioned extending between the top support members 1 such that each end of the bar member 21 may be substantially adjacent to at least one of the top support members 1. The collapsed position of the bar member 21 may be defined as when the bar member 21 is positioned such that at least one end of the bar member 21 is not substantially adjacent to at least one of the top support members 1. When the bar member 21 is in the extended position, one end of the bar member 21 and/or the bar connector 1320 of the bar member 21 may be operable to be reversibly attached to a top support member 1 that the end of the bar member 21 is substantially adjacent therewith. When the bar member 21 is in the extended position, the front shield member 30 may be prevented from moving to the collapsed position from the extended position.

Each top support member 1 may include a bar through hole 1328 that may extend into a side portion of the top support member 1. The bar through hole 1328 may be positioned at a lower portion of the top support member 1 such that the bar through hole 1328 may be extending into the top support member 1 from more than one side of the top support member 1. For example, without limitation, the bar through hole 1328 may be extending into a top support member 1 through an interior side and a bottom side of the top support member 1, as illustratively shown with the top support member 1 on the right-hand side in FIG. 13. Those skilled in the art will notice and appreciate that the bar through hole 1328 may be extending into a top support member 1 through an interior side and a bottom side of the top support member 1 may allow for the bar member 1318 with an end attached to the top support member 1 via this bar through hole 1328 to pivotally move about the bar through hole 1328 and the top support member 1 such that the bar member 1318 may pivotally move to the collapsed position and be substantially positioned between and substantially parallel with the leg members 18 of the side member 6 carrying the top support member 1 while in the collapsed position.

The bar through hole 1328 may also be positioned extending through a majority and/or extending entirely through a top support member 1. For example, without limitation, the bar through hole 1328 may extend entirely through a lower portion of a top support member 1 from an interior side to an exterior side of the top support member 1 as illustratively shown with the top support member 1 illustrated on the left-hand side in FIG. 13. The bar through hole 1328 may extend through a lower portion of a top support member 1 from an interior side to an exterior side of the top support member 1 such that the bar through hole 1328 forms a lower channel along a lower portion of the top support member 1 from the interior side to the exterior side of the top support member 1. Those skilled in the art may notice and appreciate that the lower channel formed in the top support member 1 may allow for the first end of the bar member 1318 to be pivotally and/or pivotally moved about the second end of the bar member 1318, which is pivotally attached to a lower portion and/or bar through hole 1328 of another top support member 1, such that the bar member 1328 may be aligned with the same horizontal plane with the top support members 1 when the bar member 1328 is in the extended position.

When the reversible attachment of the end of the bar member 21 and/or of the bar connector 1320 to a top support member 1 is reversed and/or detached, the bar member 21 may be allowed to move to the collapsed position, and may allow for the bar member 21 to pivotally move and/or pivotally move about an end of the bar member 21 that may be pivotally attached to the other top support member 1. For example, without limitation, When the reversible attachment of the end of the bar member 21 and/or of the bar connector 1320 to a top support member 1 is reversed and/or detached, the bar member 21 may pivotally move and/or pivotally move about the end of the bar member 21 pivotally attached to the other top support member 1 such that the bar member 21 may be positioned substantially parallel with the side members 6 and/or the leg members 18. The bar connector 1320 may comprise a knob that may be operable to reversibly and fixedly attach itself and/or the respective end of the bar member 21 to one of the top support members 1.

Some embodiments of the present invention may comprise one or more foot connection members 19. The foot connection members 19 may be positioned at a lower portion of the side members 6 and/or at a lower portion of the leg members 18 of the side members 6. Each foot connection member 19 may comprise a wheel member 1312, such as, without limitation, a castor, a wheel, a wheel assembly, a wheel lock, a castor lock mechanism, and/or a wheel motor. The wheel lock and/or the castor lock may be operable to prevent the wheel member 1312 from rotatably moving. However, it is contemplated that the foot connection members 19 may not comprise a wheel or castor and may comprise a grip foot such as, without limitation, a rubber foot, a latex foot, and/or a composite foot which may have a relatively high static coefficient of friction and/or a relatively high sliding coefficient of friction. Further details on the foot connection members 19 and the wheel members 1312 follows below.

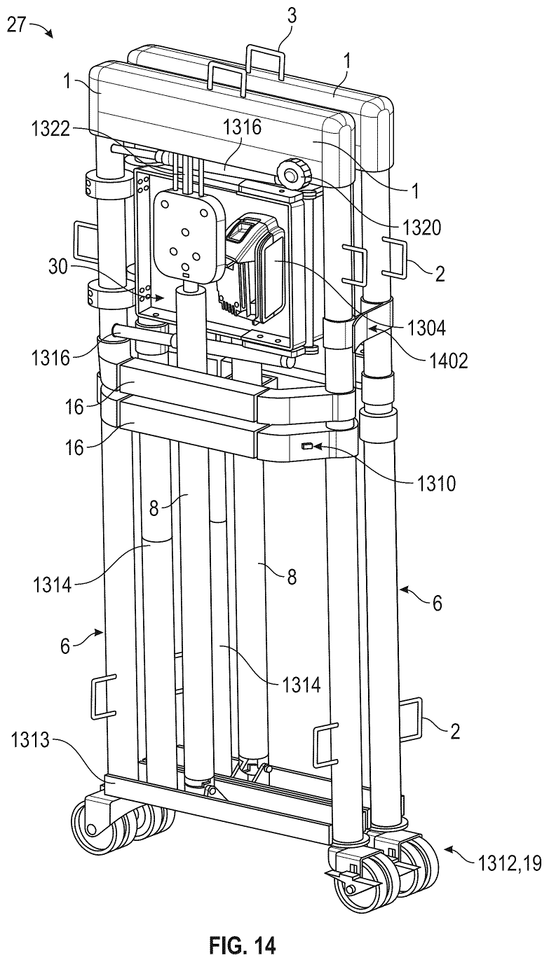

Some embodiments of the present invention may include one or more of a lock member 1402 as illustrated in FIG. 14. The lock member 1402 may be pivotally connected to a side member 6 and/or to a leg member 18 of a side member 6. The lock member 1402 may include a lock end that may be sized and configured to be reversibly attached to another side member 6 and/or to another leg member 18 of another side member 6. The lock member 1402 may be operable to be pivotally moved between a locked position and an unlocked position. The unlocked position of the lock member 1402 may be defined as when the lock end is not reversibly attached to a side member 6 and/or a leg member 18 of a side member 6. The locked position of the lock member 1402 may be defined as when the lock end of the lock member 1402 is reversibly attached to a side member 6 and/or a leg member 18 of a side member 6. The lock member 1402 may be sized and configured to only be allowed to move to the locked position when the front/first/second shield member(s) 30, 10, 13 is/are moved to the collapsed position such that the side members 6 and/or leg members 18 of the side members 6 are a distance from one another that may be close to and/or about equal to a length between the lock end and the end of the lock member 1402 that is pivotally attached to a side member 6 / leg member 18. When the lock member 1402 is in the locked position, the front/first/second shield member(s) 30, 10, 13 may be prevented from moving to the extended position from the collapsed position.

Some embodiments of the present invention may comprise one or more hoist assemblies 8. In some preferred embodiments of the present invention, the lifting device 27 may comprise a number of hoist assemblies 8 equal to the number of side members 6 of the lifting device 27. For example, without limitation, the lifting device 27 may comprise two side members 6 and two hoist assemblies 8 as illustrated in FIG. 13. Each hoist assembly 8 may be carried by a respective side member 6. The hoist assembly 8 may be positioned between and parallel with the leg members 18 of the respective side member 6 that the hoist assembly 8 is carried thereby. Each side member 6 may comprise a lower support 1313 positioned at a lower portion of the side member 6. The lower support 1313 may extend between the leg members 18 of the side member 6 and the lower support 1313 may be connected to a lower portion of each leg member 18 of the side member 6 and to a lower portion of the hoist assembly 8 carried by the side member 6. The lower support 1313 may also be connected to, rotatably attached to, and/or pivotally attached to one or more of the foot connection members 19 and/or to one or more of the wheel members 1312. The foot connection members 19 and/or the wheel members 1312 may also be connected to, rotatably attached to, and/or pivotally attached to one or more of the leg members 18 and/or the side members 6. The foot connection members 19 and/or the wheel members 1312 may be configured to swivel with respect to the lower support 1313, leg member 18, and/or side member 6 that the foot connection member 19/wheel member 1312 is connected/attached thereto.

The hoist assemblies 8 may be operable to be moved between and/or actuated between an extended position and a collapsed position. The collapsed position of the hoist assemblies 8 may be defined as when the hoist assemblies 8 are operably moved and/or operably actuated to have a total height that is equal to and/or less than a distance between a lower portion of the top support member 1 and the lower support 1313 when the respective side member 6 and/or the leg members 18 of the respective side member 6 are in the collapsed position. The extended position of the hoist assemblies 8 may be defined as when the hoist assemblies 8 are operably moved and/or operably actuated to have a height that is shorter by a predetermined amount than the distance between the lower portion of the top support member 1 and the lower support 1313 when the respective side member 6 and/or the leg members 18 are in the extended position. The hoist assemblies 8 may include, without limitation, one or more of a hydraulic actuator, a pneumatic actuator, an electric actuator, an electromechanical actuator (EMA), an electrohydraulic actuator, a motor, linear motor, a rotary motor, a thermal actuator, a magnetic actuator, a mechanical actuator, a soft actuator, a gear, a cog, a spring, a pulley, a chain, a rope, a tie, a belt, and any combinations thereof.

Each hoist assembly 8 may comprise a bumper 1322 and/or a pulley member 1602. The pully member 1602 may be positioned at an upper end of the hoist assembly 8. The bumper 1322 may be positioned at and/or connected to an upper end of the hoist assembly 8 and/or the bumper 1322 may be positioned at and/or connected to an upper portion of the pulley member 1602. The bumper 1322 may have a height substantially equal to the predetermined amount of heigh difference between the lower portion of the top support member 1 and the lower support 1313 when the respective side member 6 and/or the leg members 18 are in the extended position. When the hoist assemblies 8 are operably moved and/or operably actuated from the collapsed position to the extended position, the hoist assemblies 8, the pulley members 1602 of the hoist assemblies 1602, and/or the bumper 1322 of the hoist assemblies 8 may apply a force against the lower portion of the top support members 1 to move the side members 6 and/or the leg members 18 to the extended position.

When the side members 6 and/or the leg members 18 are moved to the extended position, the engagement members 1310 may automatically move to the engaged position, and/or the engagement members 1310 may be operable to move to the engaged positioned from the released position. In preferred embodiments of the present invention, the hoist assemblies 8 are operably moved and/or operably actuated between the collapsed position and the extended position together in unison and/or synchronously. However, it is contemplated that the hoist assemblies 8 may by operably moved and/or operably actuated between the extended and collapsed position alternatingly, asynchronously, and/or separately. Each hoist assembly 8 may comprise, without limitation, a Linear Actuator, a Pneumatic Actuator, a Hydraulic Actuator, an Electric Actuator, a Rod Actuator, and/or Rod-less Actuator, and any combination thereof.

Now referring to FIGS. 13 and 16, the pulley member 1602 of each hoist assembly 8 may be in communication with at least a portion of the load member 26. Embodiments of the present invention may include one or more pulley units 1604 that may be and rotatably carried within each pulley member 1602. The pulley units 1604 may be positioned within each pulley member 1602 to be in communication with at least a portion of the load member 26. Each the pulley unit 1604 may be positioned and configured to rotatably move about a mid-axis thereof and to guide and rotatably grasp at least a portion of the load member 26 within the pulley member 1602. Each pulley unit 1604 may comprise, without limitation, a bearing such as a pulley bearing and/or a roller bearing.

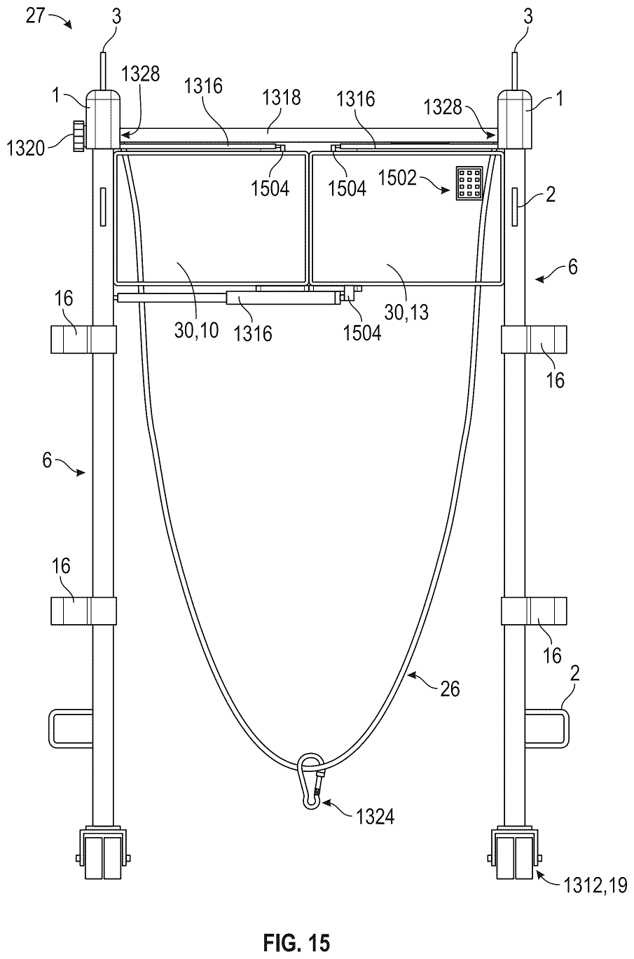

Now additionally referring to FIG. 15, embodiments of the present invention may include an attachment member 1324. Although only a single attachment member 1324 is illustrated, those skilled in the art will appreciate that the present invention contemplates the use of multiple attachment members 1324 as needed. The attachment member 1324 may be attached to and/or carried by a portion of the load member 26. In some embodiments of the present invention, the attachment member 1324 may be reversibly attached to and/or removably carried by the load member 26. The attachment member 1324 may be configured to be reversibly grasp and/or reversibly attached to items, objects, apparatuses, and/or articles, such as and without limitation, a harness, a restraint, a seat, a chair, a bed, and/or a platform, which may be worn, adorned, and/or occupied by a person such as a patient in a medical care facility or person receiving assistance or in the process of receiving of medical attention or care. The attachment member 1324 may comprise, for example, without limitation, a carabineer as illustrated in FIGS. 13 and 15. However, it is contemplated that the attachment member 1342 may comprise any number of attachment devices such as, and without limitation, a harness, a hook, a clasp, a sling, a strap, a quickdraw, maillons, D-rings, a prusiks, an anchor plate, a rope clamp, a load distributor, slipping clutches, and any combinations thereof and any other attachment device that may be used as the attachment member 1324 configured to reversibly grasp and/or reversibly attached to items, objects, apparatuses, and/or articles as may be understood by those who may have skill in the art.

Now referring to FIGS. 13-16, when the side members 6 and/or the leg members 18 are in the extended position, and the engagement members 1310 are in the engaged position, the hoist assemblies 8 may be moveable to the extended position and the collapsed to move the load member 26 between a released position and a retracted position. The retracted position of the load member 26 may be defined as when a mid-section of the load member 26 is positioned substantially between the upper portions of the side members 6. The retracted position of the load member 26 may also be defined as when the load member 26 is substantially extending between the top support members 1. The released position of the load member 26 may be defined as when the mid-section of the load member 26 is positioned substantially between and/or below mid-portions of the side members 6. The released position of the load member 26 may also be defined as when the mid-section of the load member 26 is positioned substantially between and/or below the lower supports 1313 and/or substantially between and/or below the foot connection members 19/wheel members 1312 of each side member 6.

As mentioned above, the load member 26 may have each end thereof carried by a respective top support member 1. A first end of the load member 26 may be attached to a first one of the top support members 1 and/or attached to a retention member 1608 within a first one of the top support members 1. The load member 26 may travel from the first one of the top support members 1 and to and through a portion of a first hoist assembly 8 and/or through a portion of a first pulley unit 1604 of the first hoist assembly 8 that may be carried by the same side member 6, which may be defined as a first side member 6. The load member 26 may travel along and be in communication with one or more pulley units 1604 carried by and/or within the first pulley unit 1604 and/or the first hoist assembly 8 and may travel into and through the first top support member 1 and/or a first top pulley 1606 within the first top support member 1. The load member 26 may travel from the first top pulley 1606 to and through a passage 1326 extending through a side portion of the first top support member 1, which may be defined as a first passage 1326. The load member 26 may travel from the first passage 1326 to a second passage 1326 extending through a second top support member 1 on a second side member 6. The load member 26 may travel from the second passage into and through the second top support member 1 and/or a second top pulley 1606 housed within the second top support member 1.

From the second top pulley 1606, the load member 26 may travel through a bottom portion of the second top support member 1 and to and through a portion of a second hoist assembly 8 and/or through a portion of a second pulley unit 1604 of the second hoist assembly 8 which may be carried by another side member 6, that may be defined as a second side member 6. The load member 26 may travel along and be in communication with one or more pulley units 1604 carried by and/or within the second pulley unit 1604 and/or the second hoist assembly 8 and the load member 26 may travel into the second top support member 1 to such that a second end of the load member 26 may be attached to a second retention member 1608 within the second top support member 1.

Each retention member 1608 may be carried by, housed by, and/or fixedly attached within, a respective top support member 1. The top pulleys 1606 may also be carried by, housed by, and/or fixedly attached within, a respective top support member 1. The top pulleys 1606 may be in communication with a respective portion of the load member 26, and the top pulleys 1606 may each comprise a housing and a movement portion that may rotatably move relative to the top pulley 1606 housing. Examples of the top pulley 1606 include, without limitation, a bearing and housing, and a pully bearing. In some embodiments of the present invention, the top pulleys 1606 may comprise a force application member that applies a rotational force on the movement portion of the top pulley 1606 to rotatably move the movement portion such that the load member 26 may be wrapped around the top pulley(s) 1606 and/or the load member 26 may be moved to the retracted position caused by the rotational force of the force application member(s).

The force application member may apply a rotational force on the movement portion of the top pulley 1606 which may be equal to a predetermined force value such that the load member 26 may be moved to the retracted position when an attachment member 1324 carried by the load member 26 is not attached to an object, harness, article, and/or items listed above that the attachment member 1324 may be reversibly attached thereto. In some embodiments of the present invention, the force application member may be operable to selectively apply a rotational force on the movement member of the top pulley 26 such that the load member 26 may be moved to the retracted position. In yet other embodiments of the present invention, without limitation, the top pulley 1606 may not include a force application member, such that the top pulley 1606 may comprise only a housing and a movement member.

For example, without limitation, the force application member may comprise a constant force member, such as, without limitation, a constant force spring, that may apply a constant force to the movement member of the top pulley 26 to move the load member 26 to the retracted position when the attachment member 1324 carried by the load member 26 is not attached to an object, harness, article, and/or items listed above that the attachment member 1324 may be reversibly attached thereto. For another example, without limitation, the force application member may comprise a selectively controllable force application member, such as and without limitation, a motor or actuator, that may be operable to selectively apply a rotational force on the movement member of the top pulley 26 such that the load member 26 may be moved to the retracted position.

Some embodiments of the present invention may include one or more of a conduits 1314. Each conduit 1314 may be carried by one of the side members 6. The conduit 1314 may be positioned adjacent to and/or parallel with one of the hoist assemblies 8 and/or leg members 18. The conduits 1314 may be movable between a collapsed position and an extended position. The conduits 1314 may comprise telescopic tubing, and the conduits 1314 may be configured to carry wiring therein and therethrough. The wiring carried within and traveling through the conduits 1314 may comprise coiled wiring that may be raveled and unraveled as the conduit 1314 moves between the collapsed position and the extended position.

In some embodiments of the present invention, one or more of the side members 6, the leg members 18, and/or conduits 1314 may be configured to be telescopically movable between the extended position and the collapsed position, and may include one or more of a wiper component positioned between two telescopically movable portions of the side member 6, the leg member 18, and/or conduit 1314. The wiper component may be sized and configured to act as an air gasket to cause the telescopically movable portions to cause a resistance force opposing the movement between the collapsed position and the extended position such that the two telescopically movable portions move at a reduced speed and/or rate than if the two telescopically movable portions were moved between the collapsed position and the extended position without the wiper component.

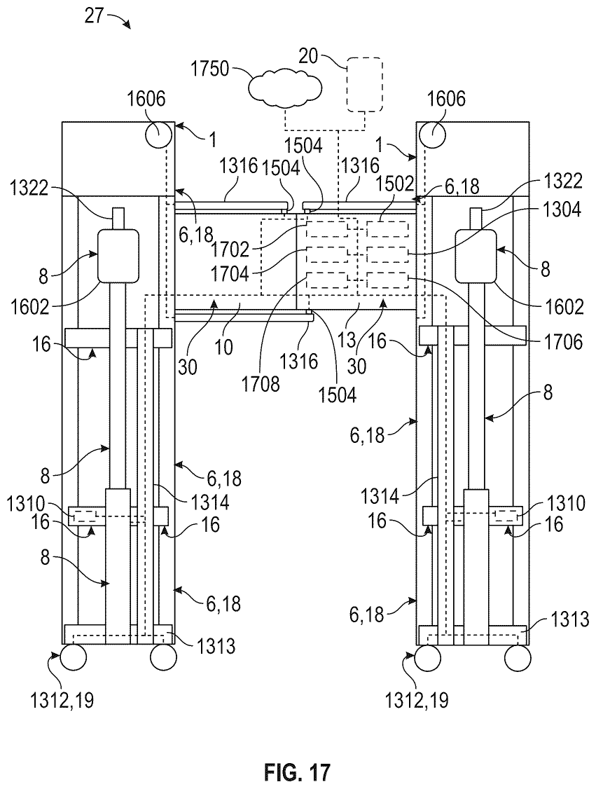

Now additionally but more specifically referring to FIG. 17, some embodiments of the present invention may include one or more a power unit 1304, an input interface 1502, a control unit 1702, a datastore 1704, a memory 1706, and/or a communication unit 1708. The power unit 1304 may be utilized to regulate, supply, and/or provide power, such as electrical power, to one or more components of an embodiment of the lifting device 27. For example, without limitation, the power unit 1304 may be in communication with, and may regulate, supply, and/or provide power to one or more of the hoist assemblies 8, the foot connection members 19, the input interface 1502, the engagement member(s) 1310, the wheel members 1312, the piston members 1316, the top pulleys 1606, the control unit 1702, the datastore 1704, the memory 1706, and/or the communication unit 1708.

For the purposes of the description of the present invention, it should be understood that the term “optionally powered components” may be used to refer to one or more of the hoist assemblies 8, the foot connection members 19, the input interface 1502, the engagement member(s) 1310, the wheel members 1312, the piston members 1316, the top pulleys 1606, the control unit 1702, the datastore 1704, the memory 1706, the communication unit 1708, and/or the power unit 1304 individually, in entirety, and/or in any combinations thereof without any limitation asserted or implied thereby. The power unit 1304 may be carried by the front shield member 30 and/or carried by the first/second shield member(s) 10, 13. However, although it is not illustrated in the figures, it is contemplated and understood that the power unit 1304 may be carried by any other component of an embodiment of the lifting device 27 such as, without limitation, a side member 6, a leg member 18, a lower support 1313, a top support member 1, a connecting support member 16, and/or a hoist assembly 8.

The power unit 1304 may be reversibly engaged, reversibly mounted, and/or reversibly coupled in communication with a power connection (not shown) on the front shield member 30 to regulate, supply, and/or provide power. Although the power connection on the front shield member 30 is not illustrated in the figures, it is understood that power connections to connect a power supply, such as the power unit 1304, is well known in the art such that it does not need further explanation thereof herein. When the power unit 1304 is in communication with the power connection, the power unit 1304 may be in communication with any one or more of the aforementioned components of an embodiment of the lifting device 27 to regulate, supply, and/or provide power thereto.

Examples of the power unit 1304 include, without limitation, a power generator, a battery, a power regulator, an inverter, a rectifier, an electrical fuse, an electrical breaker, and/or a power line utilized to be removably engaged with a power outlet as may be understood by those who may have skill in the art. In some more preferred embodiments of the present invention, the power unit 1304 may comprise a readily available power supply, such as a common power tool power supply, power bank, and/or battery and may be understood by those who may have skill in the art. The power connection of the front shield member 30 may be configured to be reversibly engaged, reversibly mounted, and/or reversibly coupled in communication with a power unit 1304 that comprises a common power tool power supply.

The input interface 1502 may be caried by and/or mounted on the front shield member 30. The input interface may be in communication with one or more of the optionally powered components, such as, without limitation, the control unit 1702. The input interface 1502 may be utilized to emit one or more of an input interface signal upon an input being made with the input interface 1502, such as, without limitation, upon an input made with the input interface 1502 by a user which may be referred to as a user input. Examples of the input interface 1502 may comprise, without limitation, one or more of a button, a key or keypad, a knob, a switch, a dial, a lever, a joystick, a touchpad, a trackball, and any combinations thereof and any other input device that may be used as the input interface 1502 as may be understood by those who may have skill in the art.

In some embodiments of the present invention, the input interface 1502 may include a display that may be in communication with the control unit 1702. The display of the input interface 1502 may be utilized to display one or more status identifiers and information. For example, and without limitation, the display of the input interface 1502 may be utilized to display one or more status identifiers and information including one or more of a load amount on the load member 26, a power status of the power unit 1304, a malfunction identifier, an on status, and an off status.

In some embodiments of the present invention, the input interface 1502 may comprise a receiver, transmitter, and/or transceiver and the input interface 1502 may be operable to be in communication with one or more of a remote 20 and/or user device 20. For the purposes of the description of the present invention, the terms remote 20 and user device 20 may be used interchangeably and may be used to refer to one another individually and/or in combination without any limitation intended or implied thereby. The communication between the input interface 1502 and the user device 20 may be a wired and/or a wireless communication. The communication between the input interface 1502 and the user device 20 may also be via a network 1750 that may be in communication with the input interface 1502, the user device 20, and/or the optionally powered components. The user device 20 may emit a user device input signal based on an input made with and/or via the user device 20. The user device input signal may be received by the input interface 1502 and/or received by one or more of the optionally powered components. Upon the user device input signal being received by the input interface 1502, the user device input signal may interchangeably be referred to as an input interface signal without any limitation implied thereby. The input interface 1502 may send the user device input signal to one or more of the optionally powered components, such as, without limitation, to the control unit 1702. Further details on the input interface input signal and the user device input signal follow below.

The user device 20 and/or remote 20 may comprise, without limitation, one or more of a remote controller, a terminal, a computation device, a laptop, a tablet, a smartphone, a smartwatch, and any combinations thereof and any other device that may be used as the user device 20/remote 20 as described herein as may be understood by those who may have skill in the art. The network 1750 may include, without limitation, one or more of a wireless network, a wired network, a router, a network hub, a network switch, a ethernet connection, a network server, a satellite network, a cellular network, a local access network, a world-wide network, a communication access point, a communication repeater, Bluetooth communication, radio communication, ad-hoc communication, point-to-point communication, and any combinations thereof and any other device, component, and/or network that may be utilized as the network 1750 as described herein as may be understood by those who may have skill in the art.

The communication unit 1708 may be in communication with one or more of the optionally powered components and the communication unit 1708 may be operable to be coupled in communication with the network 1750 and/or the user device 20. Communication between the communication unit 1708 and the user device 20 may be via the network 1750. The communication unit 1708 may be utilized to receive, send, transmit, transceive, manage, facilitate, compute, and/or interpret computer readable information, data, signals, code, commands, and/or executables as may be understood by those who may have skill in the art. Examples of the communication unit 1708 include, without limitation, a network card, a network interface card, a wired or wireless communication adapter, a router, an ethernet connector/connection, a modem, a switch, a bridge, and any combinations thereof and any other device or component that may be utilized as the communication unit 1708 as described herein as may be understood by those who may have skill in the art. It should be understood, that in some embodiments of the present invention the input interface 1502 and the communication unit 1708 may be one and the same such that the input interface 1502 and the communication unit 1708 may have all and/or some of the same features, limitations, and examples listed thereof as one another, such that an embodiment of the present invention may only include an input interface 1502 or a communication unit 1708, and such that the input interface 1502 and the communication unit 1708 may be used to refer to one another interchangeably without any limitation implied thereby.

The datastore 1704 and the memory 1706 may be in communication with one another and the datastore 1704 and/or the memory 1706 may be in communication with one or more of the optionally powered components, such as, without limitation, the control unit 1702 and the power unit 1304. The datastore 1704 and the memory 1706 may be utilized to receive, send, read, write, manage, store, and/or index computer readable information, data, signals, code, commands, and/or executables as may be understood by those who may have skill in the art. The datastore 1704 and/or the memory 1706 may be configured to be accessed by the control unit 1702 such that the control unit 1702 may access and receive computer-readable data and/or information from the datastore 1704 and/or the memory 1706. Examples of the datastore 1704 include, without limitation, a hard disk drive, a solid state drive, a flash drive, a compact disc, cloud data storage, magnetic tape, a floppy disk, and/or any combinations thereof and any other device or component that may be utilized as the datastore 1704 as described herein as may be understood by those who may have skill in the art.

Examples of the memory 1706 include, without limitation, Random Access Memory (RAM), Read-Only Memory (ROM), Cache Memory, Virtual Memory, Video Random Access Memory (VRAM), Flash Memory, Dynamic Random Access Memory (DRAM), Static Random Access Memory (SRAM), Synchronous Dynamic Random Access Memory (SDRAM), Magneto resistive Random Access Memory (MRAM) and any combinations thereof and any other device or component that may be utilized as the memory 1706 as described herein as may be understood by those who may have skill in the art. It should be understood that embodiments of the lifting device 27 may include a data bus (not shown) such as a motherboard or other local mounting and/or computer communication facilitating device and/or printed circuit board or breakout board that may be utilized to carry and/or couple one or more of the optionally powered components in communication with one another, such as, and without limitation, the control unit 1702, the power unit 1304, the input interface 1502, the datastore 1704, the memory 1706, the communication unit 1708, the network 1750, and/or the user device 20 and/or any combinations thereof.

The control unit 1702 may be in communication with one or more of the optionally powered components, such as, and without limitation, one or more of the hoist assemblies 8, the foot connection members 19, the input interface 1502, the engagement member(s) 1310, the wheel members 1312, the piston members 1316, the top pulleys 1606, control unit 1702, the datastore 1704, the memory 1706, the communication unit 1708, and/or the power unit 1304 and any combinations thereof. The control unit 1702 may be operable to control, manage, and/or monitor, and/or send and receive signals to and from one or more of the optionally powered components, such as, and without limitation, the hoist assemblies 8, the foot connection members 19/wheel members, the engagement member(s) 1310, the piston members 1316, and/or the top pulleys 1606. The control unit 1702 may comprise, without limitation, one or more of a processor, a microcontroller, a co-processor, a graphics processing unit, a central processing unit, multicore processor, an advanced RISC machine (ARM) processor, an accelerated processing unit (APU), a field-programmable gate array, and any combinations thereof and any other device that may be used as the control unit 1702 as may be understood by those who may have skill in the art.

The control unit 1702 may be configured to selectively control one or more of the hoist assemblies 8 to move and/or actuate one or more of the hoist assemblies 8 between the collapsed position and the extended position. The control unit 1702 may be configured to selectively control one or more of the hoist assemblies 8 to move and/or actuate one or more of the hoist assemblies 8 between the collapsed position and the extended position based on a user device input signal and/or an input interface input signal received by the control unit 1702.

In some embodiments of the present invention, the control unit 1702 may also be configured to selectively control one or more of the foot connection members 19/wheel members 1312 to rotatably move relative to the side members 6 and/or the lower supports 1313 to cause the lifting device 27 to travel along a ground surface and/or surface that the foot connection members 19/wheel members 1312 may be in physical contact therewith. The control unit 1702 may further be configured to selectively control one or more of the foot connection members 19/wheel members 1312 to rotatably move based on a user device input signal and/or an input interface input signal received by the control unit 1702.

In some embodiments of the present invention, the control unit 1702 may be configured to selectively control one or more of the piston members 1316 to cause one or more of the piston members 1316 to move and/or actuate to and/or between the collapsed position and the extended position, which may concurrently cause the front shield member 30 to move between the collapsed position and the extended position. The control unit 1702 may be configured to selectively control one or more of the piston members 1316 to cause one or more of the piston members 1316 to move and/or actuate to and/or between the collapsed position and the extended position based on a user device input signal and/or an input interface input signal received by the control unit 1702.

In some embodiments of the present invention, the control unit 1702 may also be configured to selectively control one or more of the top pulleys 1606 to cause one or more of the top pulleys 1606 to rotatably move such that the load member 26 may be wrapped around the top pulley(s) 1606 and/or the load member 26 may be moved to the retracted position. In some embodiments of the present invention, the control unit 1702 may comprise a receiver, a transmitter, and/or a transceiver that may be operable to receive a user device input signal that may be sent and/or emitted from a user device 20. The control unit 1702 may be configured to be in communication with the user device 20 and/or the network 1750. The control unit 1702 may also be configured to be in communication with the user device 20 via the network 1750.

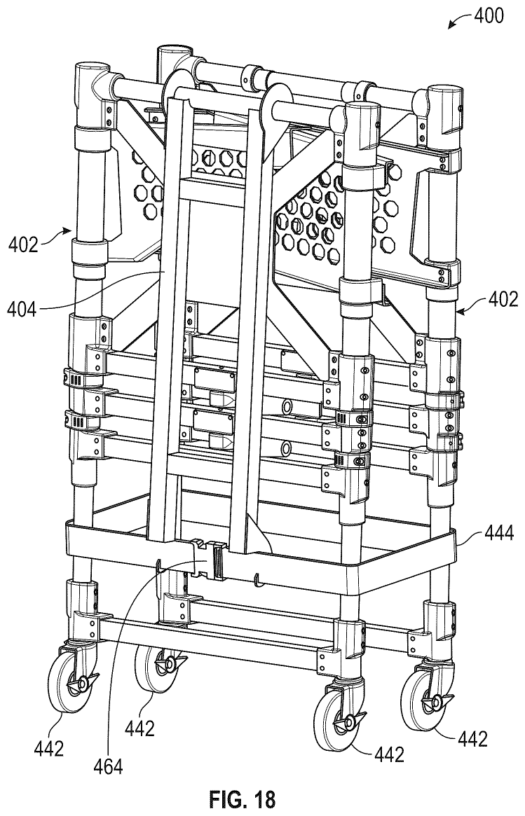

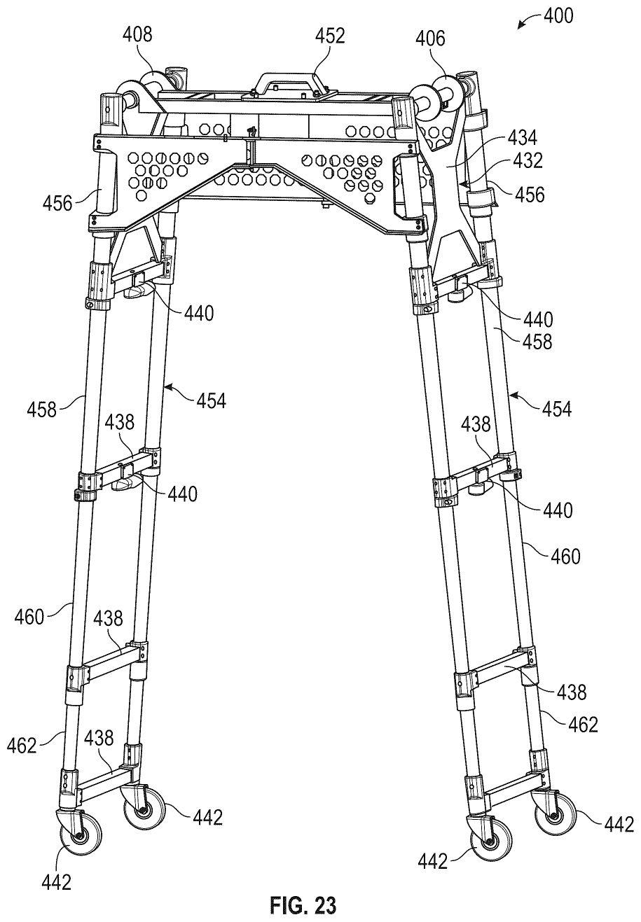

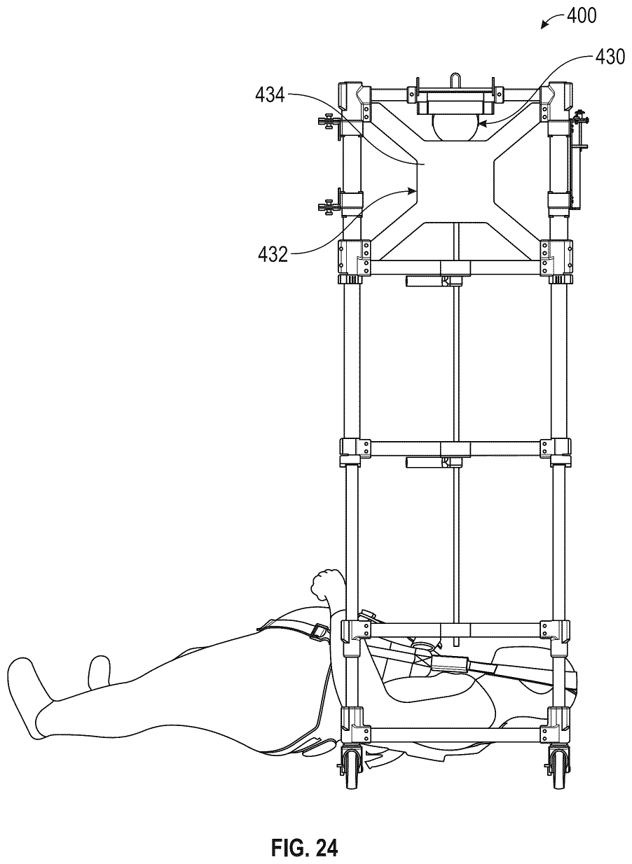

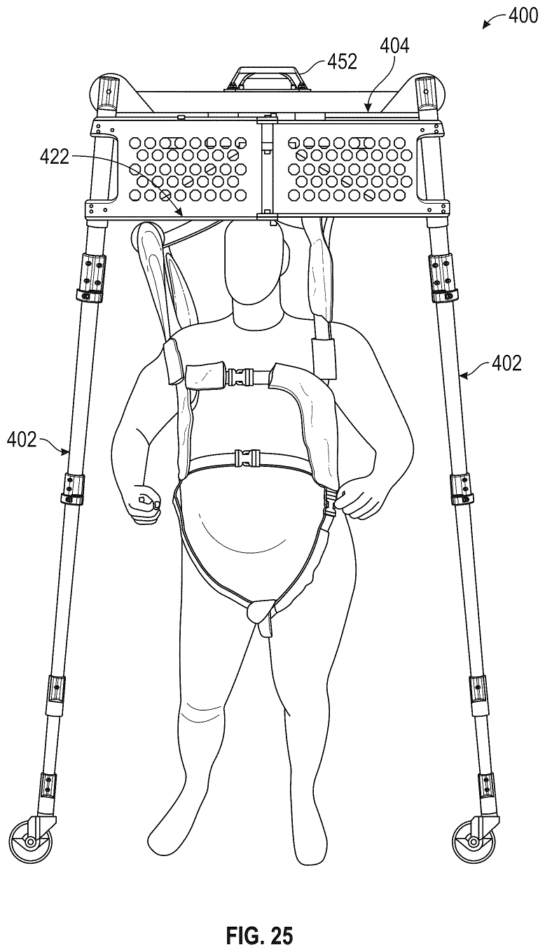

Referring now additionally to FIGS. 18-29, additional features of another embodiment of the lifting device 400 according to the present invention are now described. The lifting device 400 is illustrated in FIG. 18 with portions thereof in collapsed positions to be configured to be readily transported. For example, the lifting device 400 in the configuration illustrated in FIG. 18 is ready to be moved and/or stored. The lifting device 400 according to this embodiment of the present invention is suitable to be stored in a small storage area, can be stored in a compartment of a patient transport, such as an ambulance, or can be stored in any other location as understood by those skilled in the art. However, and as perhaps best illustrated in FIG. 23, the lifting device 400 according to embodiments of the present invention can have its components moved to extended positions to be configured to be used to lift a patient, which is helpfully illustrated in FIGS. 24 and 25.

The lifting device 400 according to the present invention may include a pair of side members 402 which are moveable between a collapsed position and an extended position. The lifting device 400 may also include a top support member 404. The top support member 404 may have a first end 406 that is rotatably connected to a top of a first one 410 of the pair of side members 402. The top support member 404 may also have a second end 408 positioned opposite the first end 406. The second end 408 of the top support member 404 may be adapted to be removable connected to a top of a second one 412 of the pair of side members 402.

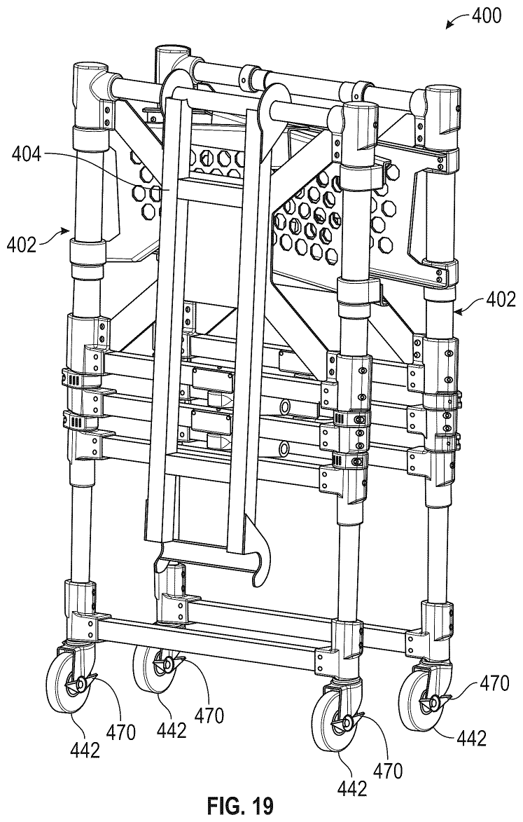

The lifting device 400 may also include a front member 414 and a rear member 422. The front member 414 may be moveable between a collapsed position and an extended position. FIGS. 18 and 19 show the front member 414 in the collapsed position. Additional details of the collapsed position and the extended position of both the front member 414 and the rear member 422 will be provided in greater detail below. The front member 414 may have a first end 416 that is connected to an upper side portion of the first one 410 of the pair of side members 402. The front member 414 may also have a second end 418 connected to an upper side portion of the second one 412 of the pair of side members 402. Further, the front member 414 may also include a medial hinged portion 420.

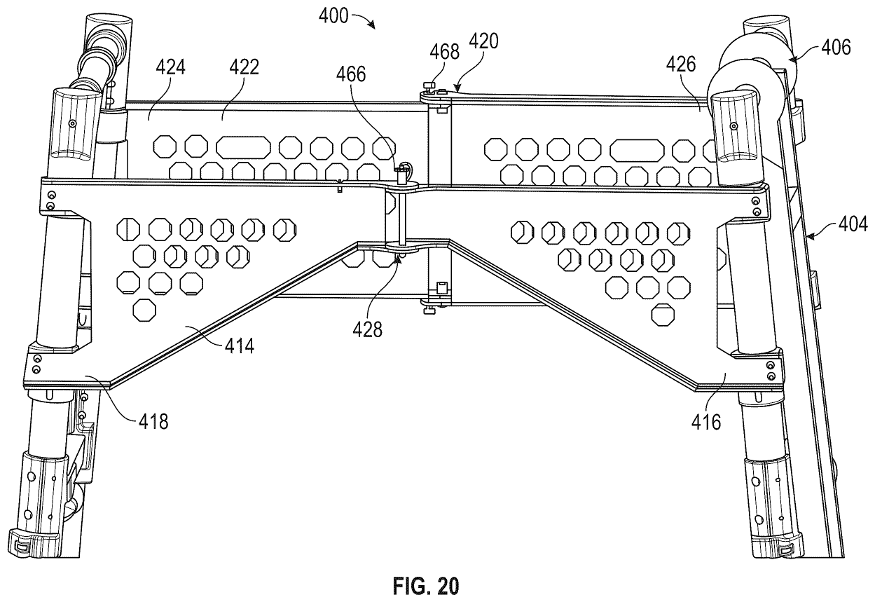

As illustrated, for example, in FIG. 20, the front member 414 may include a pin member 466 that can be removably connected to the medial hinged portion 420. When the pin member 466 is positioned to engage the medial hinged portion 420, the front member is prevented from moving between the collapsed position and the extended position. When the pin member is disengaged from the medial hinged portion 420, the front member 414 may freely move between the collapsed position and the extended position.

The rear member 422 of the lifting device 400 may also be moveable between a collapsed position and an extended position. Similar to the movement of the front member 414, the rear member 422 is shown in the collapsed position in FIGS. 18 and 19 and is shown in the extended position in FIGS. 20-23, and FIGS. 25-29. The rear member 422 may have a first end 424 connected to an upper side portion of the first one 410 of the pair of side members 402 and a second end 426 connected to an upper side portion of the second one 408 of the pair of side members 402. The rear member 422 may also include a medial hinged portion 428.

As also illustrated, for example, in FIG. 20, the rear member 422 may include a release member 468 that can be engaged to allow the rear member 422 to move between the collapsed position and the extended position. When the release member 468 is engaged, the rear member 422 is able to freely move between the collapsed position and the extended position, and when the release member 468 is disengaged, the rear member is prevented from moving between the collapsed position and the extended position.

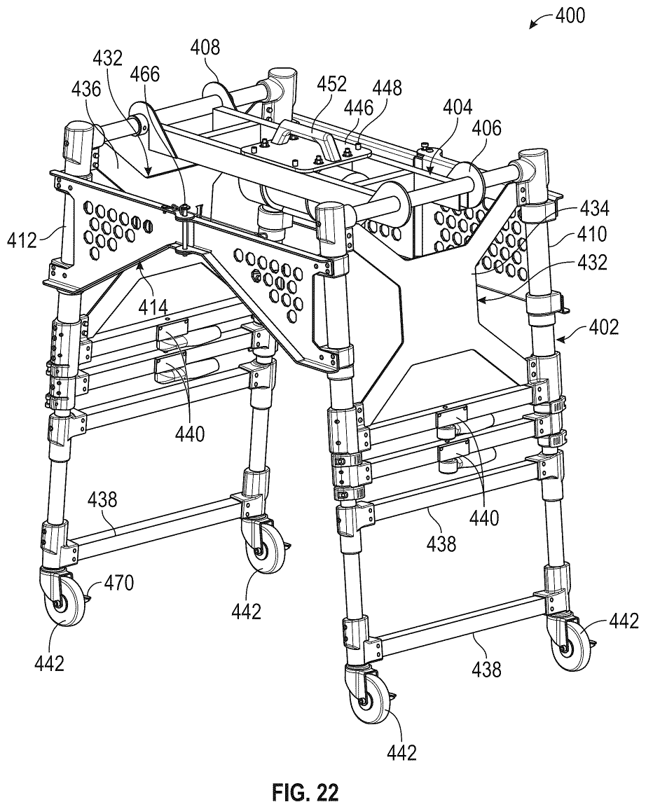

As perhaps best illustrated in FIGS. 22-28, the lifting device 400 may include a hoist member 430 that is removably carried by the top support member 404. The present invention contemplates that the hoist member 430 can be provided by a device similar to a winch, for example, and can be remotely operated to move the hoist member between extended positions and retracted positions. The extended position of the hoist member 430 is contemplated as the line of the hoist member 430 being extended from a spool of the hoist member. The retracted position of the hoist member 430 is contemplated as the line carried by the spool of the hoist member being retracted to be carried by the spool. In operation, the hoist member 430 would be moved to an extended position so that a connection member (shown above and described in greater detail) that may be connected to an end portion of the line can be extended to be connected to, for example, a harness that may be positioned on a patient, to lift the patient. Once the connection member is connected to a portion of the harness, the hoist member 430 may be moved from the extended position to the retracted position to thereby lift the patient.

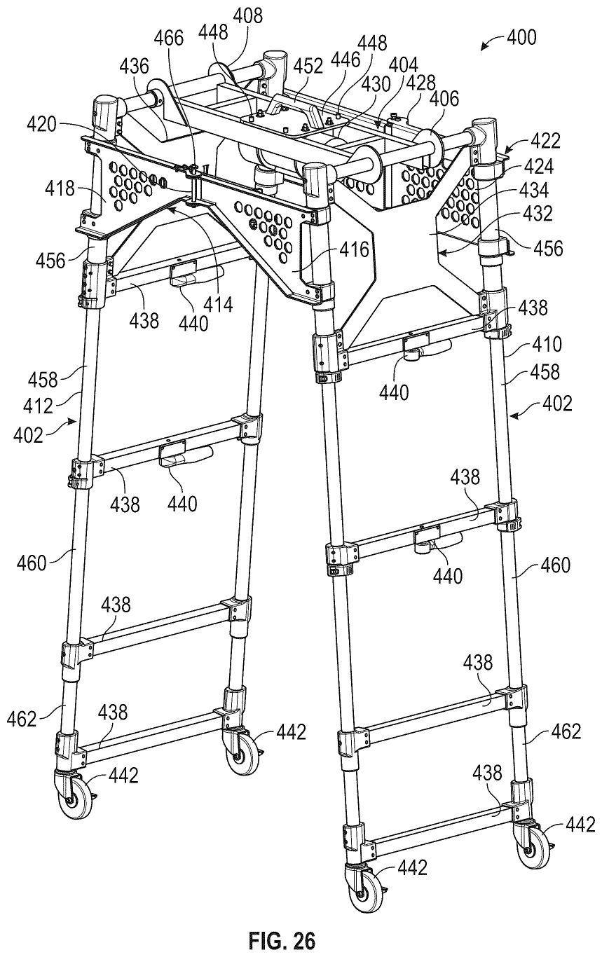

The hoist member 430 is illustrated as sitting atop the top support member 404. It is contemplated that portions of the hoist member 430 may be affixed to the top support member 404. For example, and as illustrated in FIGS. 26-28, the hoist member 430 may include a hoist member plate 446, which may include a plurality of passageways that are adapted to receive hoist member fasteners 448. The hoist member fasteners 448 may be adapted to pass through the passageways in the hoist member plate 446 and engage with a respective plurality of hoist member fastener receiving portions 450 to secure the hoist member 430 on the top support member 404. A handle member 452 may also be connected to a top portion of the hoist member plate 446. The inclusion of the handle member 452 advantageously allows a user to readily move and position the hoist member 430 where necessary.

The lifting device 400 illustrated in FIG. 18 shows the side members 402 in the collapsed position and the front and rear members 414, 422 also in the collapsed position. When both the side members 402 and the front and rear members 414, 422 are in the collapsed position, the lifting device 400 is suitable for ready transport. As will be discussed in greater details below, the lifting device 400 illustratively includes wheel members 442 to allow for ease in movement and transport thereof. The lifting device 400 according to embodiments of the present invention may also include a securing strap 444 that may be configured to wrap around bottom portions of the side members 402 to keep the side members 402 and the front and rear members 414, 422 in the collapsed position. In the illustrated embodiment, the securing strap 444 is also positioned to engage a portion of the top support member 404 when the top support member 404 is rotatably moved to a disengaged, or storage position. The securing strap 444 may be made of any material suitable for securing portions of the side members 402 and the top support member 404 and may also include a clip portion 464 to secure the strap member. The clip portion 464 may allow for the securing strap 444 length to be adjusted to provide a tighter or a looser fit when used to secure portions of the side members 402 and the top support member 404.

As further illustrated in the appended figures, the lifting device 400 may also include a pair of opposing side support members 432. A first one 434 of the pair of side support members 432 may be connected to the first one 410 of the pair of side members 402. A second one 436 of the pair of side support members 432 may be connected to the second one 412 of the pair of side members 402. The side support members 432 may advantageously increase the strength and stability of the lifting device 400 according to the present invention by adding additional structural integrity. This can also advantageously allow for heavier loads to be lifted using the lifting device 400 according to the present invention.

As can be seen in FIG. 23, each of the side members 402 may include a plurality of side member legs 454. The side member legs 454 are configured to slidably engage one another and, more specifically, can be arranged to slidably engage one another in a nesting configuration. More particularly, the nested configuration may be defined as upper side member legs 454 of the plurality of side member legs of each of the pair of side members 402 being sized to slidably engage a side member leg positioned therebelow. As illustrated, the side members 402 can be collapsed twice. Therefore, each of the side members 402 include an upper side member leg 456, an upper medial side member leg 458 and a lower medial side member leg 460, and a lower side member leg 462. When moving the side members 402 from the extended position to the collapsed position, the upper medial side member leg 458 slidably engages the upper side member leg 456. Thereafter, the lower medial side member leg 460 slidably engages the upper medial side member leg 458, and the lower side member leg 462 slidably engages the lower medial side member leg 460. It is contemplated by the present invention that the side member legs 454 may have increasing diameters when going from either the upper side member leg 456 down to the lower side member leg 462, or vice versa. In other words, it is contemplated that the nesting of the side member legs 454 may occur from top to bottom, or from bottom to top. Both configurations are meant to be included in the present invention. Therefore, during the nesting process, the upper side member leg 456 is sized to be positioned interior to the upper medial side member leg 458 which, in turn, is sized to be positioned interior to the lower medial side member leg 460 which, in turn, is sized to be positioned interior to the lower side member leg 462. Conversely, the present invention contemplates that the lower side member leg 462 may be sized to be positioned interior to the lower medial side member leg 460 which, in turn, may be sized to be positioned interior to the upper medial side member leg 458 which, in turn, may be sized to be positioned interior to the upper side member leg 456 during the nesting process.

As indicated above, each of the front member 414 and the rear member 422 is moveable between an extended position and a collapsed position. Each of the front member 414 and the rear member 422 includes a medial hinged portion 420, 428. The medial hinged portion 420 of the front member 414 may be moved to bring the first end 416 of the front member 414 and the second end 418 of the front member 414 in closer proximity to one another. In other words, the front member 414 may be folded along the medial hinged portion 420 thereof. Similarly, the medial hinged portion 428 of the rear member 422 may be moved to bring the first end 424 of the rear member 422 and the second end 426 of the rear member 422 in closer proximity to one another. Accordingly, the rear member 422 may be folded along the medial hinged portion 428 thereof.

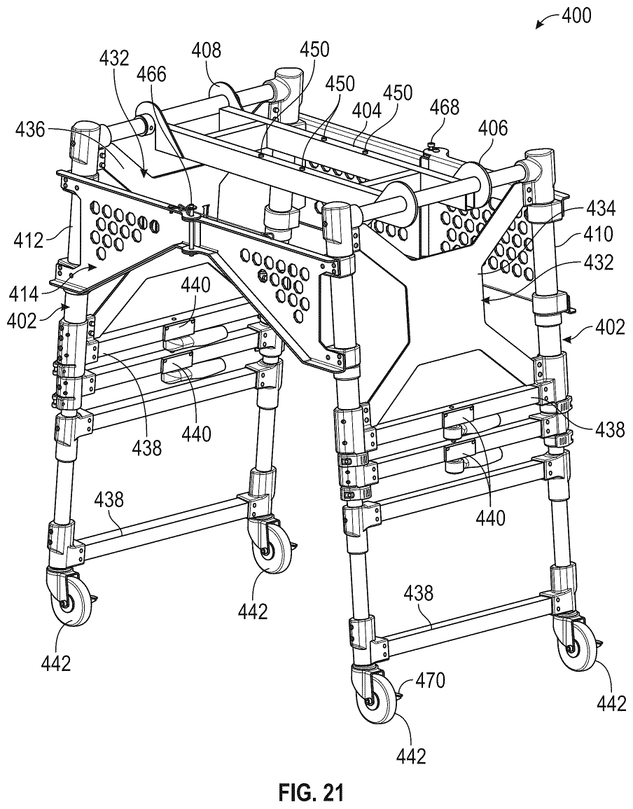

The top support member 404 may be moveable between an engaged position and a disengaged position. The top support member 404 is illustrated in the engaged position, for example, in FIGS. 21-23 and in FIGS. 25-29. The engaged position is defined as the top support member 404 being in a substantially horizontal position and the second end 408 of the top support member 404 engaging the upper side portion of the second one 412 of the pair of side members 402. The disengaged position is defined as the top support member 404 being in a position other than the substantially horizontal position. This is perhaps best illustrated in FIGS. 18-20. In the disengaged position, the second end 408 of the top support member 404 is disengaged from the upper side portion of the second one 412 of the pair of side members 402. To move the top member 404 to the disengaged position, the first end 406 of the top support member 404 is rotated in a downwardly direction. As can be seen, for example, in FIGS. 18-20, when the top support member 404 is in the disengaged position, it is in a substantially vertical position with the first end 406 of the top support member 404 being connected to a portion of the first one 410 of the pair of side members. As illustrated in FIG. 18, when the top support member 404 is in the disengaged position, the securing strap 444 may engage the second end 408 of the top support member 404 to secure the top support member 404 in the disengaged position.

The lifting device 404 may also include connecting support members 438. The connecting support members 438 are connected to each of the pair of side members 402. More particularly, the connecting support members 438 are positioned to extend between the pair of side members 402 and are preferably positioned in the vicinity where the side member legs 454 slidably engage with one another during the nesting process. The lifting device may also include a lock member 440 carried by the connecting member 438. The lock member 440 is moveable between a locked position and an unlocked position. When in the locked position, the side member legs 454 are prevented from slidably moving. In other words, and for example, when in the locked position, the lock member 440 prevents the upper side member leg 456 from slidably moving with respect to the upper medial side member leg 485 which, in turn, is prevented from slidably engaging the lower medial side member leg 460 which, in turn, is prevented form slidably engaging the lower side member leg 462. In order to allow the side member legs 454 to slidably engage one another, the lock member 440 is moved to the unlocked position. Accordingly, when the lock member 440 is in the unlocked position, the side member legs 454 can slidably move between the collapsed position and the extended position. In the illustrated embodiment, the lock member 440 is connected to the upper two connecting support members 438 but those skilled in the art will appreciate that the lock members 440 may be positioned on as many connecting support members 438 as are necessary to allow for the side members to be moved between the extended position and the collapsed position.

The lifting device 400 may also include wheel members 442. The wheel members 442 may be connected to a bottom portion of the side members 402. More specifically, the wheel members 442 may be connected to a bottom portion of each of the lower side member legs 462. The wheel members 442 may, for example, be provided by casters, or any other type of wheel suitable for allowing the lifting device 400 to be moved. The wheel members 442 may also have locks 470 associated therewith that may be moved between a locked position and an unlocked position. When in the locked position, the wheel members 442 may be prevented from rotating, thereby preventing movement. When in the unlocked position, the wheel members 442 may be allowed to rotate, thereby allowing movement.

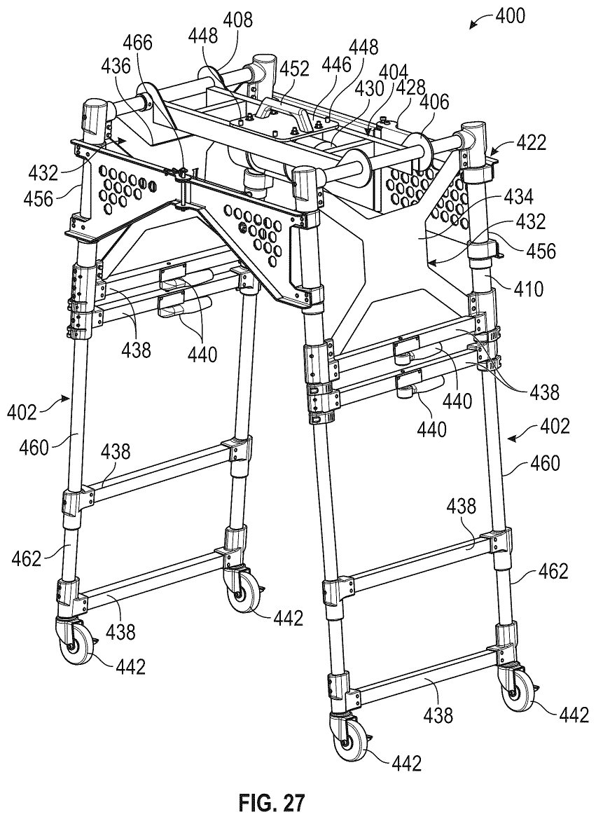

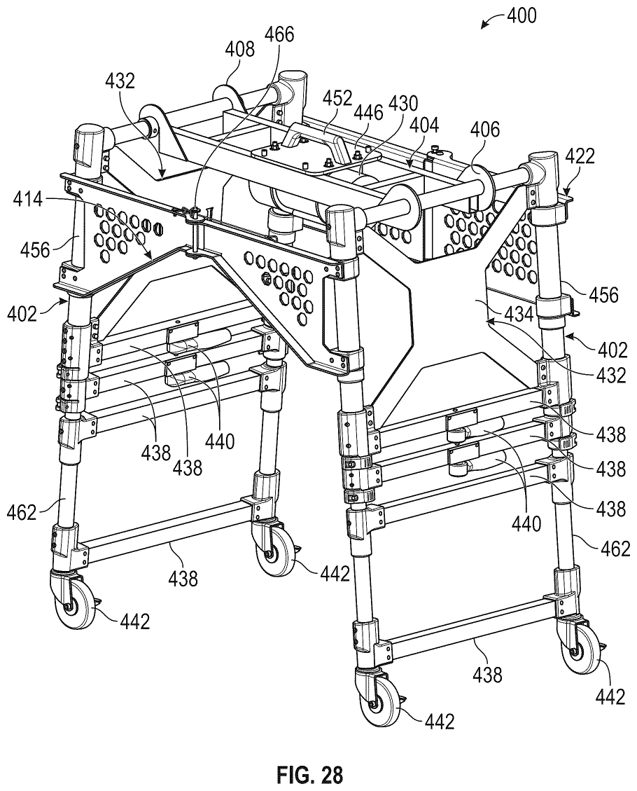

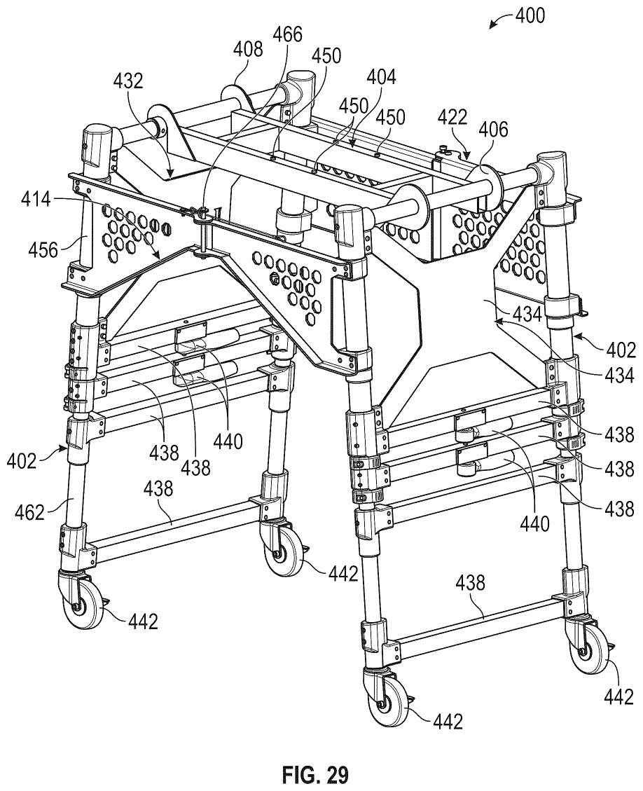

The lifting device 400 illustrated in FIG. 26 is shown with the side members 402 in a fully extended position. The lifting device 400 illustrated in FIG. 27 is shown with the side members 402 being partially collapsed. The lifting device 400 illustrated in FIG. 28 is shown with the side members 402 also being partially collapsed, but more collapsed than the side members 402 shown in FIG. 27. Finally, the lifting device 400 illustrated in FIG. 29 is shown with the side members 402 being in the same collapsed position as the side members 402 shown in the illustration of the lifting device 400 illustrated in FIG. 28, but the hoist member 430 has been removed therefore. This series of figures is meant to illustrate the ease with which the lifting device 400 according to embodiments of the present invention may be used, moved, and collapsed as needed.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

The claims in the instant application are different than those of the parent application or other related applications. Applicant therefore rescinds any disclaimer of claim scope made in the parent application or any predecessor application in relation to the instant application. Any such previous disclaimer and the cited references that it was made to avoid, may need to be revisited. Further, any disclaimer made in the instant application should not be read into or against the parent application.

What is claimed is:

1. A lifting device comprising:
a pair of side members movable between a collapsed position and an extended position;
a top support member having a first end rotatably connected to a top of a first one of the pair of side members, and a second end positioned opposite the first end and removably connected to a top of a second one of the pair of side members;
a front member moveable between a collapsed position and an extended position, the front member having a first end connected to an upper side portion of the first one of the pair of side members, a second end connected to an upper side portion of the second one of the pair of side members, and a medial hinged portion;
a rear member moveable between a collapsed position and an extended position, the rear member having a first end connected to an upper side portion of the first one of the pair of side members, a second end connected to an upper side portion of the second one of the pair of side members, and a medial hinged portion; and
a hoist member that is removably carried by the top support member.

2. The device of claim 1, further comprising a pair of opposing side support members, wherein a first one of the pair of side support members is connected to the first one of the pair of side members and a second one of the pair of side support members is connected to the second one of the pair of side members.

3. The device of claim 1, wherein each of the pair of side members comprises a plurality of side member legs that are in a nested configuration.

4. The device of claim 3, wherein the nested configuration is defined as upper side member legs of the plurality of side member legs of each of the pair of side members being sized to slidably engage a side member leg positioned therebelow.

5. The device of claim 4, wherein the collapsed position of each of the pair of side members is defined as at least one of the plurality of side member legs slidably engaging an adjacent one of the plurality of side member legs positioned therebelow so that the upper side member legs are positioned interior to lower side member legs; and wherein the extended position of each of the pair of side members is defined as each of the plurality of side member legs being extended outwardly from the adjacent one of the plurality of side member legs.

6. The device of claim 1 wherein the collapsed position of each of the front member and the rear member is defined as the hinged medial portion being moved to bring the first end and the second end in closer proximity to one another.

7. The device of claim 6 wherein the top support member is moveable between an engaged position and a disengaged position; wherein the engaged position is defined as the top support member being in a substantially horizontal position and the second end of the top support member engaging the upper side portion of the second one of the pair of side members; and wherein the disengaged position is defined as the top support member being in a position other than the substantially horizontal position, the second end of the top support member being disengaged from the upper side portion of the second one of the pair of side members, and the first end of the top support member being rotated in a downwardly direction.

8. The device of claim 5 further comprising at least one connecting support member connected to each of the pair of side members.

9. The device of claim 8 further comprising a lock member carried by the at least one connecting member; wherein the lock member is moveable between a locked position and an unlocked position; wherein when in the locked position, the plurality of side member legs are prevented from slidably moving; and wherein when in the unlocked position, the plurality of side member legs can slidably move between the collapsed position and the extended position.

10. The device of claim 1, further comprising at least one wheel member connected to at least one of the pair of side members.

11. A lifting device comprising:
a pair of side members movable between a collapsed position and an extended position;
a top support member having a first end rotatably connected to a top of a first one of the pair of side members, and a second end positioned opposite the first end and removably connected to a top of a second one of the pair of side members;
a front member moveable between a collapsed position and an extended position, the front member having a first end connected to an upper side portion of the first one of the pair of side members, a second end connected to an upper side portion of the second one of the pair of side members, and a medial hinged portion; and
a rear member moveable between a collapsed position and an extended position, the rear member having a first end connected to an upper side portion of the first one of the pair of side members, a second end connected to an upper side portion of the second one of the pair of side members, and a medial hinged portions;
wherein each of the pair of side members comprises a plurality of side member legs that are in a nested configuration;
wherein the nested configuration is defined as upper side member legs of the plurality of side member legs of each of the pair of side members being sized to slidably engage a side member leg positioned therebelow;
wherein the collapsed position of each of the pair of side members is defined as at least one of the plurality of side member legs slidably engaging an adjacent one of the plurality of side member legs positioned therebelow so that the upper side member legs are positioned interior to lower side member legs;
wherein the extended position of each of the pair of side members is defined as each of the plurality of side member legs being extended outwardly from the adjacent one of the plurality of side member legs;
wherein the collapsed position of each of the front member and the rear member is defined as the hinged medial portion being moved to bring the first end and the second end in closer proximity to one another; and
wherein the top support member is moveable between an engaged position and a disengaged position; wherein the engaged position is defined as the top support member being in a substantially horizontal position and the second end of the top support member engaging the upper side portion of the second one of the pair of side members; and wherein the disengaged position is defined as the top support member being in a position other than the substantially horizontal position, the second end of the top support member being disengaged from the upper side portion of the second one of the pair of side members, and the first end of the top support member being rotated in a downwardly direction.

12. The device of claim 11, further comprising a pair of opposing side support members, wherein a first one of the pair of side support members is connected to the first one of the pair of side members and a second one of the pair of side support members is connected to the second one of the pair of side members.

13. The device of claim 11, further comprising a hoist member that is removably carried by the top support member.

14. The device of claim 11 further comprising at least one connecting support member connected to each of the pair of side members.

15. The device of claim 14 further comprising a lock member carried by the at least one connecting member; wherein the lock member is moveable between a locked position and an unlocked position; wherein when in the locked position, the plurality of side member legs are prevented from slidably moving; and wherein when in the unlocked position, the plurality of side member legs can slidably move between the collapsed position and the extended position.

16. A lifting device comprising:
a pair of side members movable between a collapsed position and an extended position;
a top support member having a first end rotatably connected to a top of a first one of the pair of side members, and a second end positioned opposite the first end and removably connected to a top of a second one of the pair of side members;
a front member moveable between a collapsed position and an extended position, the front member having a first end connected to an upper side portion of the first one of the pair of side members, a second end connected to an upper side portion of the second one of the pair of side members, and a medial hinged portion;
a rear member moveable between a collapsed position and an extended position, the rear member having a first end connected to an upper side portion of the first one of the pair of side members, a second end connected to an upper side portion of the second one of the pair of side members, and a medial hinged portions; and
a plurality of wheel members, each connected to a lower portion of each of the pair of side members; and
at least one connecting support member connected to each of the pair of side members; and
a lock member carried by the at least one connecting member;
wherein the collapsed position of each of the front member and the rear member is defined as the hinged medial portion being moved to bring the first end and the second end in closer proximity to one another;
wherein the top support member is moveable between an engaged position and a disengaged position;
wherein the engaged position is defined as the top support member being in a substantially horizontal position and the second end of the top support member engaging the upper side portion of the second one of the pair of side members;
wherein the disengaged position is defined as the top support member being in a position other than the substantially horizontal position, the second end of the top support member being disengaged from the upper side portion of the second one of the pair of side members, and the first end of the top support member being rotated in a downwardly direction;
wherein the lock member is moveable between a locked position and an unlocked position;
wherein when in the locked position, the plurality of side member legs are prevented from slidably moving; and
wherein when in the unlocked position, the plurality of side member legs can slidably move between the collapsed position and the extended position.

17. The device of claim 16, further comprising a pair of opposing side support members, wherein a first one of the pair of side support members is connected to the first one of the pair of side members and a second one of the pair of side support members is connected to the second one of the pair of side members.

18. The device of claim 16, wherein each of the pair of side members comprises a plurality of side member legs that are in a nested configuration.

19. The device of claim 18, wherein the nested configuration is defined as upper side member legs of the plurality of side member legs of each of the pair of side members being sized to slidably engage a side member leg positioned therebelow.

20. The device of claim 19, wherein the collapsed position of each of the pair of side members is defined as at least one of the plurality of side member legs slidably engaging an adjacent one of the plurality of side member legs positioned therebelow so that the upper side member legs are positioned interior to lower side member legs; and wherein the extended position of each of the pair of side members is defined as each of the plurality of side member legs being extended outwardly from the adjacent one of the plurality of side member legs.
